(19) United States
(12) Patent Application Publication
(10) Pub. No.: US 2021/0147240 A1
(43) Pub. Date: May 20, 2021

(54) CARBON-ALKALINE EARTH METAL CATALYSTS FOR HYDRAZINE OXIDATION AND OXYGEN REDUCTION

(71) Applicant: TECHNION RESEARCH & DEVELOPMENT FOUNDATION LIMITED, Haifa (IL)

(72) Inventors: David EISENBERG, Migdal HaEmeq (IL); Tomer BURSHTEIN, Haifa (IL); Eliyahu FARBER, Haifa (IL)

(21) Appl. No.: 16/951,216

(22) Filed: Nov. 18, 2020

Related U.S. Application Data
(60) Provisional application No. 62/936,707, filed on Nov. 18, 2019.

(51) Int. Cl. C01B 32/20; C01B 32/198; C01B 32/158; C25B 3/02; C25B 11/14; C25B 11/03

(52) U.S. Cl. CPC C01B 32/20; C01B 32/198; C01B 32/158; C25B 3/02; C25B 11/14; C01P 2004/13; C01P 2006/12; C01P 2006/14; C01P 2006/16; C01P 2004/64; C25B 11/035

(57) ABSTRACT

A composition comprising a porous carbon material comprising mesopores, micropores, marcopores, or any combination thereof, is provided. Further, articles comprising the composition and methods of preparing same are provided. Further, a process of oxidizing hydrazine is provided.

### CROSS-REFERENCE TO RELATED APPLICATION

This application claims the benefit of priority of U.S. provisional patent application No. 62/936,707 filed Nov. 18, 2019, and entitled “CARBON-ALKALINE EARTH METAL CATALYSTS FOR HYDRAZINE OXIDATION,” which is hereby incorporated herein by reference in its entirety.

### FIELD OF THE INVENTION

The present invention is in the field of material science and electrocatalysis.

### BACKGROUND OF THE INVENTION

Today's human transportation is based on fossil fuels, which are inefficient and polluting. A promising alternative is using fuel cells as a clean and energy-efficient transportation power source. Fuel cells separate fuel oxidation and oxidant reduction, so usable electricity is generated. However, the most researched fuel for fuel cells, hydrogen (H₂) gas, is hard to transport and store. Moreover, fuel cells are expensive because their electrode materials are made from precious metals. There is a need for alternative fuel sources with easier and safer transportation, and more stable electrodes made of cheaper and more abundant materials.

Oxygen redox catalysis, including the oxygen reduction reaction (ORR) and oxygen evolution reaction (OER), is crucial in determining the electrochemical performance of energy conversion and storage devices such as fuel cells, metal-air batteries and electrolyzers. At the current stage of technology, platinum (Pt)-based materials are the most practical catalysts. Because these Pt-based catalysts are too expensive for making commercially viable fuel cells.

The oxidation of hydrazine (N₂H₄) is an important challenge in electrocatalysis, with applications in direct hydrazine fuel cells and in medical and environmental sensing. Noble metals such as palladium (Pd) and gold (Au) catalyze the HzOR effectively, yet their scarcity calls for earth-abundant alternatives.

Therefore, there is still a great need for new materials that have the ability to compete with the known precious metals in the reduction of oxygen, and hydrazine oxidation, as a practical alternative to the expensive metals.

### SUMMARY OF THE INVENTION

According to one aspect, there is provided a composition comprising a porous carbon material comprising mesopores, micropores, macropores, or any combination thereof, wherein the composition is characterized by (i) a total pore volume between of 0.01 cm³ g⁻¹ and 4 cm³ g⁻¹ and (ii) a specific surface area (SSA) between 50 m² g⁻¹ and 2000 m² g⁻¹.

In some embodiments, the micropores are characterized by a total volume between 0.01 and 0.6 cm³ g⁻¹.

In some embodiments, the mesopores and the macropores are characterized by a total volume between 0.09 and 4 cm³ g⁻¹.

In some embodiments, the carbon material is doped with 0.2 at. % to 5 at. % nitrogen.

In some embodiments, the pores are void.

In some embodiments, the pores comprise an alkaline earth metal compound comprising magnesium, calcium, strontium, barium, or any combination thereof.

In some embodiments, the alkaline earth metal compound is in the form of nanoparticles.

In some embodiments, the nanoparticles are characterized by a diameter in the range of 1 nm to 60 nm.

In some embodiments, the alkaline earth metal compound is characterized by crystallite size in the range of 3 nm to 40 nm, as determined by the Scherrer method.

In some embodiments, the carbon material comprises graphite, carbon black, graphene, reduced graphene oxide, graphene oxide, carbon microfibers, carbon nanofibers, carbon nanotubes, carbon nanowires, glassy carbon, amorphous carbon, or any combination thereof.

In some embodiments, the composition is for use in hydrazine oxidation reaction (HzOR), oxygen reduction reaction (ORR), or both.

According to another aspect, there is provided an article comprising the composition of the present invention, wherein the composition is deposited on at least one surface of the article.

In some embodiments, the article is in the form of a cathode. In some embodiments, the article is in the form of an anode.

In some embodiments, the loading of the composition is in the range of 0.01 mg cm⁻² to 0.3 mg cm⁻².

According to another aspect, there is provided an electrochemical cell comprising the article of the present invention.

In some embodiments, the electrochemical cell is configured to oxidize hydrazine at onset potentials in the range of 0.2 V vs. reversible hydrogen electrode (RHE) to 0.8 V vs. RHE.

In some embodiments, the electrochemical cell operates in alkaline environment. In some embodiments, the electrochemical cell operates in acidic environment.

According to another aspect, there is provided a process of oxidizing hydrazine, the process comprising: (i) contacting a hydrazine containing solution with the electrochemical cell of the present invention, and (ii) applying an anodic electric potential to the electrochemical cell, thereby oxidizing the hydrazine.

According to another aspect, there is provided a method for preparing the composition of the present invention, comprising: (i) providing one or more earth metal-coordination polymer precursor comprising magnesium, calcium, strontium, barium, or any combination thereof; and (ii) pyrolysing the earth metal-coordination polymer precursor, thereby obtaining the porous carbon material.

In some embodiments, the method further comprises step (iii) of washing the doped earth metal-carbon material, thereby obtaining the porous carbon material.

In some embodiments, pyrolysing is at a temperature ranging from of 450° C. to 1000° C.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Further embodiments and the full scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 Presents a schematic representation of the self-templating strategy towards hierarchically porous carbon catalysts: pyrolysis of a Ba²⁺-nitrilotriacetate metal-coordination polymer yields a complex array of BaCO₃ nanoparticles embedded in a carbon matrix, which are then washed out to leave a macro-, meso- and microporous carbon;

FIG. 2 presents a graph of thermogravimetric analysis (TGA)-differential scanning calorimetry (DSC) of Ba-NTA. Left axis: mass loss (%), right axis: heat required for temperature change (positive=exothermic). Pyrolysis temperatures selected for detailed investigation in this work are marked by arrows on the TGA trace;

FIGS. 3A-B present a powder x-ray diffractogram of the Ba-NTA-derived carbons; the peaks are assigned to different carbonate phases, δ-BaC₃, γ-BaCO₃, and Ba(OH)₂ (FIG. 3A), and Scherrer analysis of peak broadening in Ba-T samples, showing the evolution with temperature of the average size of coherently scattering crystallites (FIG. 3B);

FIGS. 4A-H present scanning electron micrographs: BaCO₃-carbon composites after pyrolysis (FIGS. 4A-D) and hierarchically porous carbons after acid wash and annealing (FIGS. 4E-H);

FIGS. 5A-C present transmission electron micrographs of the carbons pyrolyzed at 800° C.: BaC-800 before washing, inset: high magnification, with marks for the crystal spacing of BaCO₃ (FIG. 3A) and C-800 at two magnifications (FIG. 5B and FIG. 5C);

FIGS. 6A-B present N₂ sorption isotherms; inset: BET-SSA values (FIG. 6A) and a graph of pore size distribution, as calculated by QSDFT (FIG. 6B);

FIGS. 7A-C present graphs of deconvolution of XPS for C-700 in the region of N is (FIG. 7A), nitrogen atomic % on the surface of each C-T sample, broken down into nitrogen types—graphitic (N_{g}), pyridinic (Nₚ), pyrrolic (N_{py}) and oxidized (Nₒₓ), and bulk atomic % N, measured by elemental analysis (FIG. 7C);

FIGS. 8A-B present a Raman spectra, normalized for intensity, and showing mathematical deconvolution (on the C-500 spectrum) into the G, D, D″, and I bands (FIG. 8A) and intensity ratio of the D and G bands (left axis) and the in plane length of the graphitic domain (Lₐ, right axis) (FIG. 8B);

FIGS. 9A-B present cyclic voltammograms (CV) of hydrazine oxidation; the scans were conducted at 10 mV s⁻¹, 1 M KOH electrolyte (pH=14) and 10 mM of hydrazine, at 25° C.; the dashed line corresponds to the absence of hydrazine, and is similar for all samples (FIG. 9A) and line scanned voltammetry performed under similar conditions to the CV, rotated at 1600 rpm; inset: linear increase of non-faradaic current with scan rate, and the electrochemical surface area derived from the slope (FIG. 9B);

FIG. 10 presents CV of hydrazine oxidation on C-700, scan rate 50 mV s⁻¹, at hydrazine concentrations of 0, 10, 20, 30, 40, 50 and 60 mM, in 1 M KOH (pH=14), at 25° C.;

FIGS. 11A-C present CV of hydrazine oxidation, at scan rates 5, 10, 25, 50, 75 and 100 mV s⁻¹, with 10 mM hydrazine in 1 M KOH (pH=14), at 25° C. (FIG. 11A), peak I current density versus square root of scan rate (FIG. 1B), and peak II current density versus square root of scan rate (FIG. 11C);

FIG. 12 presents a schematic representation of the self-templating synthesis of hierarchically porous carbon materials, involving the precipitation, pyrolysis and washing of a well-defined metal-organic precursor;

FIGS. 13A-D present powder X-ray diffraction (XRD) of the inorganic/carbon composites following pyrolysis (MX@NC) and the final carbons following washing (NC-M), wherein M corresponds to magnesium (Mg) (FIG. 13A), calcium (Ca) (FIG. 13B), strontium (Sr) (FIG. 13C) or barium (Ba) (FIG. 13D);

FIGS. 14A-L present MX@NC inorganic/carbon composites, produced by pyrolysis of Group 2 MOCPs: HRSEM with overlaid EDS map of the Group 2 element (FIGS. 14A-D), HRTEM at two magnifications, with crystal spacings marked on representative particles (FIGS. 14E-L);

FIGS. 15A-C present adsorption-desorption isotherms on the NC-M carbons (N₂, 77 K); inset: the low pressure region for NC-Ca (FIG. 15A) and pore size distributions calculated from the isotherms by NLDFT, in the micropore (FIG. 15B) and mesopore regions (FIG. 15C);

FIGS. 16A-G present scanning electron micrographs: CaNTA crystals (FIG. 16A), composites of Ca-based inorganic phases and N-doped carbon (CaX@NC), as obtained after pyrolysis (FIGS. 16B-D); arrows in FIG. 16C point to translucent films covering the carbon, and final N-doped carbon (NC-Ca), following washing by HCl (FIGS. 16E-G);

FIGS. 17A-G present scanning electron micrographs: SrNTA crystals (FIG. 17A), composites of Sr-based inorganic phases and N-doped carbon (SrX@NC), as obtained after pyrolysis (FIGS. 17B-D); inset in FIG. 17B shows a lower magnification of the same particle, and final N-doped carbon (NC-Sr), after washing by HCl (FIGS. 17E-G);

FIGS. 18A-G present scanning electron micrographs: MgNTA crystals (FIG. 18A), composites of Mg-based inorganic phases and N-doped carbon (MgX@NC), as obtained after pyrolysis (FIGS. 18B-D), and final N-doped carbon (NC-Mg), after washing by HCl (FIGS. 18E-G);

FIGS. 19A-G present scanning electron micrographs: BaNTA crystals (FIG. 19A), composites of Ba-based inorganic phases and N-doped carbon (BaX@NC), as obtained after pyrolysis (FIGS. 19B-D), and final N-doped carbon (NC-Ba), after washing by HCl (FIGS. 19E-G);

FIG. 20 presents deconvoluted Raman spectra of the NC-M carbons;

FIGS. 21A-B presents high resolution XPS spectra of the NC-M carbons in the N is (FIG. 21A), and C is regions (FIG. 21B); intensities matched, by <30%;

FIGS. 22A-C presents linear scan RRDE voltammograms of O₂-saturated 0.1 M KOH at 25° C., scan rate at 10 mV s⁻², rotated at 1600 rpm, corrected for capacitive current as measured in a N₂-purged solution: ring current, corrected by the collection factor (FIG. 22A), disc current; inset: limiting disc current (−0.6 V vs. RHE) vs. number of N atoms per specific surface area of the carbon (FIG. 22B), and calculated percent of produced H₂O₂ (FIG. 22C);

FIG. 23 presents a scheme of the proposed mechanism for the observed oxygen reduction reaction (ORR) selectivity differences, based on competition between kinetics and mass transfer; the peroxide (HO₂⁻) intermediate can either escape (from large pores) or be reduced/disproportionated (if confined in small pores); and

FIG. 24 presents a scheme of the proposed mechanism for the observed structure-activity correlations in the NC-M carbons: hierarchical porosity enables better O₂ delivery into the particles, while confinement of peroxide in mesopores allows it to react more completely.

### DETAILED DESCRIPTION OF THE INVENTION

The present invention, in some embodiments thereof, is directed to a composition comprising a porous carbon material.

In some embodiments, the present invention provides a porous carbon material comprising a network of pores. In some embodiments, the present invention provides a hierarchically porous carbon material comprising micropores, mesopores, macropores, or any combination thereof. In some embodiments, the composition comprises a nitrogen doped hierarchically porous carbon material.

As used herein, the terms “hierarchically porous” and “hierarchical porosity” refer to the presence of at least two different pore sizes in the carbon material, i.e., at least one set of pores being microporous (d<2 nm), mesoporous (2 nm<d<50 nm and at least one set of pores being macroporous (50 nm<d). The mesopores, micropores and macropores may be arranged, with respect to each other, in any of several different ways. In some embodiments, at least one (or both, or all) of the mesopores micropores and macropores are arranged in an ordered (i.e., patterned) manner.

In some embodiments, a composition comprising a porous carbon material as described herein is a catalyst. In some embodiments, a composition comprising a porous carbon material as described herein is characterized by an improved catalytic activity towards hydrazine oxidation reaction (HzOR), oxygen reduction reaction (ORR), or both. In some embodiments, a composition comprising a porous carbon material comprising micropores, mesopores, macropores, or any combination thereof, is characterized by an increased exposure of the catalytic sites to an efficient flow of reactants and products.

In some embodiments, the present invention is directed to a method for preparing a composition comprising a porous carbon material comprising micropores, mesopores, and macropores, as described herein.

In some embodiments, the hierarchical porosity in the porous carbon material is obtained by the pyrolysis of well-designed metal-organic precursors, comprising earth metal-coordination polymer (MOCP).

As used herein “coordination polymer” refers to an infinite array composed of metal ions which are bridged by certain ligands among them. This incorporates a wide range of architectures including simple one-dimensional chains with small ligands to large mesoporous frameworks. In some embodiments, the formation process proceeds automatically and, therefore, is called a self-assembly process. Various coordination polymers are well-known in the art and would be will be apparent to those skilled in the art.

As used herein, the term “alkaline earth metal” refers to the series of elements comprising Group 2 of the Periodic Table of the Elements. “Alkaline earth metal” refers to beryllium (Be), magnesium (Mg), calcium (Ca), strontium (Sr), barium (Ba), and radium (Ra). In some embodiments, the composition comprises an alkaline earth metal oxide. The term “alkaline earth metal oxide” refers to an oxide of an alkaline earth metal, including BeO, MgO, CaO, SrO, and BaO. In some embodiments, the composition comprises an alkaline earth metal carbonate. The term “alkaline earth metal carbonate” refers to a carbonate of an alkaline earth metal, e.g. SrC₃, BaC₃, CaCO₃. In some embodiments, the composition comprises an alkaline earth metal hydroxide. The term “alkaline earth metal hydroxide” refers to a hydroxide of an alkaline earth metal, e.g. Ca(OH)₂, Sr(OH)₂. In some embodiments, the composition comprises an alkaline earth metal compound(s), complex(es) and/or salt(s) thereof. In some embodiments, the composition comprises mixtures of alkaline earth metal compounds. As used herein, the term “mixtures of alkaline earth metal compounds” refers to the use of two or more compounds of alkaline earth metals. In some embodiments, a mixture of alkaline earth metal compounds provides an enhanced catalytic activity.

In some embodiments, the composition comprises an alkaline earth metal compound. In some embodiments, the carbon material is a porous carbon material. In some embodiments, the composition is in the form of a catalyst. In some embodiments, the composition comprises a catalyst with hydrazine oxidation reaction (HzOR) activity. In some embodiments, the composition comprises a catalyst with oxygen reduction reaction (ORR) activity. In some embodiments, the composition has catalytic activity towards HzOR, ORR, or both. In some embodiments, the composition described herein has enhanced activity towards HzOR, ORR, or both. In some embodiments, the catalyst described herein has catalytic activity towards HzOR, ORR, or both, operating at low overpotentials and in a wide pH rage.

According to some embodiments, the present invention provides a composition comprising 90% to 99.9% (w/w) of a porous carbon material and less than 5% (w/w) of an alkaline earth metal. According to some embodiments, the present invention provides a composition comprising at least 95% (w/w) of a porous carbon material. According to some embodiments, the present invention provides a composition comprising at least 97% (w/w) of a porous carbon material. According to some embodiments, the present invention provides a composition comprising at least 99% (w/w) of a porous carbon material. In some embodiments, the present invention provides a composition comprising less than 5% (w/w) of an alkaline earth metal. In some embodiments, the present invention provides a composition comprising less than 2% (w/w) of an alkaline earth metal. In some embodiments, the present invention provides a composition comprising less than 1% (w/w) of an alkaline earth metal. In some embodiments, the present invention provides a composition comprising less than 0.5% (w/w) of an alkaline earth metal. In some embodiments, the present invention provides a composition comprising less than 0.1% (w/w) of an alkaline earth metal. In some embodiments, the composition is devoid of an alkaline earth metal compound.

In one embodiment, a composition, a particle, an article or a cell as described herein is characterized by a graphitization content as measured by a Raman IG/ID ratio of 0.2-2. In one embodiment, a composition, a particle, an article or a cell as described herein is identified by a graphitization content as measured by a Raman IG/ID ratio of 0.2-2. In one embodiment, a composition, a particle, an article or a cell as described herein is identified by a graphitization content as measured by a Raman IG/ID ratio of 0.2-1. In one embodiment, a composition, a particle, an article or a cell as described herein is identified by a graphitization content as measured by a Raman IG/ID ratio of 0.8-2.

### The Composition

According to some embodiments, the present invention provides a composition comprising a porous carbon material comprising mesopores, micropores, macropores, or any combination thereof.

In some embodiments, the carbon material comprises: graphite, carbon black, graphene, reduced graphene oxide, graphene oxide, carbon microfibers, carbon nanofibers, carbon nanotubes, carbon nanowires, glassy carbon, amorphous carbon, or any combination thereof. As used herein, the term “carbon material” refers to carbon containing structures. “Carbon material” according to the present invention refers to a material or substance comprised substantially of carbon. Carbon materials include ultrapure as well as amorphous and crystalline carbon materials. Example of carbon materials comprise activated carbon, mesoporous carbon, templated carbon, carbide-derived carbon, porous carbon sphere, and carbon onion. In some embodiments, carbon materials according to the present invention comprise activated carbons, i.e. materials prepared by pyrolysis. In some embodiments, carbon materials according to the present invention are prepared by pyrolysis of carbon precursors. In some embodiments, carbon precursors comprise one or more polymers, small organic molecules or small molecular weight saccharides. In some embodiments, compositions according to the present invention comprise porous carbon materials. Porous carbon materials can be classified according to their pore diameters: microporous (<2 nm), mesoporous (2-50 nm), and macroporous (>50 nm). The structure of the porous carbon material can take various forms depending on the starting material, and the manufacturing method.

As used herein, the terms “pore” and “porous” refer to an opening or depression in the surface of a catalyst or catalyst support.

In some embodiments, the composition is characterized by a total pore volume between of 0.01 cm³ g⁻¹ and 4 cm³ g⁻¹. In some embodiments, the composition is characterized by a total pore volume in the range of 0.01 cm³ g⁻¹ to 5 cm³ g⁻¹, 0.01 cm³ g⁻¹ to 4 cm³ g⁻¹, 0.05 cm³ g⁻¹ to 5 cm³ g⁻¹, 0.09 cm³ g⁻¹ to 4 cm³ g⁻¹, 0.01 cm³ g⁻¹ to 2 cm³ g⁻¹, 0.05 cm³ g⁻¹ to 2 cm³ g⁻¹, 0.09 cm³ g⁻¹ to 2 cm³ g⁻¹, 0.1 cm³ g⁻¹ to 5 cm³ g⁻¹, 0.2 cm³ g⁻¹ to 2.5 cm³ g⁻¹, 0.5 cm³ g⁻¹ to 2.5 cm³ g⁻¹, 0.7 cm³ g⁻¹ to 5 cm³ g⁻¹, 0.9 cm³ g⁻¹ to 2.5 cm³ g⁻¹, 1 cm³ g⁻¹ to 2.5 cm³ g⁻¹, 1.2 cm³ g⁻¹ to 2.5 cm³ g⁻¹, 1.5 cm³ g⁻¹ to 2.5 cm³ g⁻¹, 1.9 cm³ g⁻¹ to 5 cm³ g⁻¹, 2.0 cm³ g⁻¹ to 5 cm³ g⁻¹, 0.1 cm³ g⁻¹ to 2.0 cm³ g⁻¹, 0.2 cm³ g⁻¹ to 2.0 cm³ g⁻¹, 0.5 cm³ g⁻¹ to 2.0 cm³ g⁻¹, 0.7 cm³ g⁻¹ to 2.0 cm³ g⁻¹, 0.9 cm³ g⁻¹ to 2.0 cm³ g⁻¹, 1 cm³ g⁻¹ to 2.0 cm³ g⁻¹, 1.2 cm³ g⁻¹ to 2.0 cm³ g⁻¹, 1.5 cm³ g⁻¹ to 2.0 cm³ g⁻¹, 1.9 cm³ g⁻¹ to 2.0 cm³ g⁻¹, 0.1 cm³ g⁻¹ to 1.6 cm³ g⁻¹, 0.2 cm³ g⁻¹ to 1.6 cm³ g⁻¹, 0.5 cm³ g⁻¹ to 1.6 cm³ g⁻¹, 0.7 cm³ g⁻¹ to 1.6 cm³ g⁻¹, 0.9 cm³ g⁻¹ to 1.6 cm³ g⁻¹, 1.0 cm³ g⁻¹ to 1.6 cm³ g⁻¹, or 1.2 cm³ g⁻¹ to 1.6 cm³ g⁻¹, including any range therebetween. Each possibility represents a separate embodiment of the invention.

In some embodiments, the composition is characterized by a specific surface area (SSA) between 50 m² g⁻¹ and 2000 m² g⁻¹. In some embodiments, the composition is characterized by a surface area in the range of 70 m² g⁻¹ to 2000 m² g⁻¹, 100 m² g⁻¹ to 2000 m² g⁻¹, 200 m² g⁻¹ to 2000 m² g⁻¹, 300 m² g⁻¹ to 2000 m² g⁻¹, 500 m² g⁻¹ to 2000 m² g⁻¹, 700 m² g⁻¹ to 2000 m² g⁻¹, 800 m² g⁻¹ to 2000 m² g⁻¹, 900 m² g⁻¹ to 2000 m² g⁻¹, 1000 m² g⁻¹ to 2000 m² g⁻¹, 1200 m² g⁻¹ to 2000 m² g⁻¹, 50 m² g⁻¹ to 1300 m² g⁻¹, 70 m² g⁻¹ to 1300 m² g⁻¹, 100 m² g⁻¹ to 1300 m² g⁻¹, 200 m² g⁻¹ to 1300 m² g⁻¹, 300 m² g⁻¹ to 1300 m² g⁻¹, 500 m² g⁻¹ to 1300 m² g⁻¹, 700 m² g⁻¹ to 1300 m² g⁻¹, 800 m² g⁻¹ to 1300 m² g⁻¹, 900 m² g⁻¹ to 1300 m² g⁻¹, 1000 m² g⁻¹ to 1300 m² g⁻¹, 1200 m² g⁻¹ to 1300 m² g⁻¹, 50 m² g⁻¹ to 500 m² g⁻¹, 70 m² g⁻¹ to 500 m² g⁻¹, 100 m² g⁻¹ to 500 m² g⁻¹, 200 m² g⁻¹ to 500 m² g⁻¹, 300 m² g⁻¹ to 500 m² g⁻¹, 50 m² g⁻¹ to 900 m² g⁻¹, 70 m² g⁻¹ to 900 m² g⁻¹, 100 m² g⁻¹ to 900 m² g⁻¹, 200 m² g⁻¹ to 900 m² g⁻¹, 300 m² g⁻¹ to 900 m² g⁻¹, 500 m² g⁻¹ to 900 m² g⁻¹, 700 m² g⁻¹ to 900 m² g⁻¹, or 800 m² g⁻¹ to 900 m² g⁻¹, including any range therebetween. Each possibility represents a separate embodiment of the invention.

As used herein, the term “surface area” refers to the total surface area of a substance measurable by the BET technique.

In some embodiments, the composition comprises a porous carbon material comprising mesopores, micropores, macropores, or any combination thereof. In some embodiments, the composition comprises mesopores, micropores, macropores, or any combination thereof.

In some embodiments, the micropores are characterized by a size in the range of 0.2 nm to 5 nm, 0.5 nm to 5 nm, 0.9 nm to 5 nm, 1.0 nm to 5 nm, 0.2 nm to 3 nm, 0.5 nm to 3 nm, 0.9 nm to 3 nm, 1.0 nm to 3 nm, 1.0 nm to 2.5 nm, 1.2 nm to 5 nm, 1.5 nm to 5 nm, 1.9 nm to 5 nm, 2.0 nm to 5 nm, 0.2 nm to 2.0 nm, 0.5 nm to 2.0 nm, 0.9 nm to 2.0 nm, 1.0 nm to 2.0 nm, 1.0 nm to 2.0 nm, 1.2 nm to 2.0 nm, 1.5 nm to 2.0 nm, 1.9 nm to 2.0 nm, 2.0 nm to 2.0 nm, 0.2 nm to 1.5 nm, 0.5 nm to 1.5 nm, 0.9 nm to 1.5 nm, 1.0 nm to 1.5 nm, 1.0 nm to 1.5 nm, 1.2 nm to 1.5 nm, 0.2 nm to 1.0 nm, 0.5 nm to 1.0 nm, 2.5 nm to 5.0 nm, 0.5 nm to 2.5 nm, or 0.9 nm to 1.0 nm, including any range therebetween. Each possibility represents a separate embodiment of the invention.

In some embodiments, the mesopores are characterized by a size in the range of 3 nm to 60 nm, 5 nm to 60 nm, 10 nm to 60 nm, 15 nm to 60 nm, 20 nm to 60 nm, 3 nm to 40 nm, 5 nm to 40 nm, 10 nm to 40 nm, 15 nm to 40 nm, 20 nm to 40 nm, 25 nm to 40 nm, 30 nm to 40 nm, 35 nm to 40 nm, 3 nm to 30 nm, 5 nm to 30 nm, 10 nm to 30 nm, 15 nm to 30 nm, 20 nm to 30 nm, 25 nm to 30 nm, 3 nm to 20 nm, 5 nm to 20 nm, 10 nm to 20 nm, 15 nm to 20 nm, 3 nm to 10 nm, 5 nm to 10 nm, or 3 nm to 5 nm, including any range therebetween. Each possibility represents a separate embodiment of the invention.

In some embodiments, the macropores are characterized by a size in the rage of 60 nm to 500 nm, 70 nm to 500 nm, 90 nm to 500 nm, 100 nm to 500 nm, 60 nm to 250 nm, 70 nm to 250 nm, 90 nm to 250 nm, 100 nm to 250 nm, 60 nm to 150 nm, 70 nm to 150 nm, 90 nm to 150 nm, 60 nm to 100 nm, or 70 nm to 100 nm, including any range therebetween. Each possibility represents a separate embodiment of the invention.

In some embodiments, the micropores are characterized by a total volume between 0.01 cm³ g⁻¹ and 0.6 cm³ g⁻¹, 0.05 cm³ g⁻¹ and 0.6 cm³ g⁻¹, 0.09 cm³ g⁻¹ and 0.6 cm³ g⁻¹, 0.1 cm³ g⁻¹ and 0.6 cm³ g⁻¹, 0.12 cm³ gland 0.6 cm³ g⁻¹, 0.01 cm³ g⁻¹ and 0.5 cm³ g⁻¹, 0.05 cm³ g⁻¹ and 0.5 cm³ g⁻¹, 0.09 cm³ g⁻¹ and 0.5 cm³ g⁻¹, 0.1 cm³ g⁻¹ and 0.5 cm³ g⁻¹, 0.12 cm³ g⁻¹ and 0.5 cm³ g⁻¹, 0.01 cm³ g⁻¹ and 0.4 cm³ g⁻¹, 0.05 cm³ g⁻¹ and 0.4 cm³ g⁻¹, 0.09 cm³ g⁻¹ and 0.4 cm³ g⁻¹, 0.1 cm³ g⁻¹ and 0.4 cm³ g⁻¹, or 0.12 cm³ g⁻¹ and 0.4 cm³ g⁻¹, including any range therebetween. Each possibility represents a separate embodiment of the invention.

In some embodiments, the mesopores are characterized by a total volume between 0.01 cm³ g⁻¹ and 6 cm³ g⁻¹, 0.05 cm³ g⁻¹ and 6 cm³ g⁻¹, 0.09 cm³ g⁻¹ and 6 cm³ g⁻¹, 0.1 cm³ g⁻¹ and 6 cm³ g⁻¹, 0.12 cm³ g⁻¹ and 6 cm³ g⁻¹, 0.01 cm³ g⁻¹ and 5 cm³ g⁻¹, 0.05 cm³ g⁻¹ and 5 cm³ g⁻¹, 0.09 cm³ g⁻¹ and 5 cm³ g⁻¹, 0.1 cm³ g⁻¹ and 5 cm³ g⁻¹, 0.12 cm³ g⁻¹ and 5 cm³ g⁻¹, 0.01 cm³ g⁻¹ and 0.3 cm³ g⁻¹, 0.05 cm³ g⁻¹ and 0.3 cm³ g⁻¹, 0.09 cm³ g⁻¹ and 0.3 cm³ g⁻¹, 0.1 cm³ g⁻¹ and 0.3 cm³ g⁻¹, or 0.12 cm³ g⁻¹ and 0.3 cm³ g⁻¹, including any range therebetween. Each possibility represents a separate embodiment of the invention.

In some embodiments, the mesopores and the macropores are characterized by a total volume between 0.09 cm³ g⁻¹ and 4 cm³ g⁻¹, 0.1 cm³ g⁻¹ and 4 cm³ g⁻¹, 0.12 cm³ g⁻¹ and 4 cm³ g⁻¹, 0.5 cm³ g⁻¹ and 4 cm³ g⁻¹, 0.9 cm³ g⁻¹ and 4 cm³ g⁻¹, 0.1 cm³ g⁻¹ and 4 cm³ g⁻¹, 2 cm³ g⁻¹ and 4 cm³ g⁻¹, 0.09 cm³ g⁻¹ and 3 cm³ g⁻¹, 0.1 cm³ g⁻¹ and 3 cm g⁻¹, 0.12 cm³ g⁻¹ and 3 cm³ g⁻¹, 0.5 cm³ g⁻¹ and 3 cm³ g⁻¹, 0.9 cm³ g⁻¹ and 3 cm³ g⁻¹, 0.1 cm³ g⁻¹ and 3 cm³ g⁻¹, 2 cm³ g⁻¹ and 3 cm³ g⁻¹, 0.09 cm³ g⁻¹ and 2 cm³ g⁻¹, 0.1 cm³ g⁻¹ and 2 cm³ g⁻¹, 0.12 cm³ g⁻¹ and 2 cm³ g⁻¹, 0.5 cm³ g⁻¹ and 2 cm³ g⁻¹, 0.9 cm³ g⁻¹ and 2 cm³ g⁻¹, 0.1 cm³ g⁻¹ and 2 cm³ g⁻¹, 2 cm³ g⁻¹ and 2 cm³ g⁻¹, 0.09 cm³ g⁻¹ and 1 cm³ g⁻¹, 0.1 cm³ g⁻¹ and 1 cm³ g⁻¹, 0.12 cm³ g⁻¹ and 1 cm³ g⁻¹, 0.5 cm³ g⁻¹ and 1 cm³ g⁻¹, 0.9 cm³ g⁻¹ and 1 cm³ g⁻¹, 0.1 cm³ g⁻¹ and 1 cm³ g⁻¹, or 2 cm³ g⁻¹ and 1 cm³ g⁻¹, including any range therebetween. Each possibility represents a separate embodiment of the invention.

In some embodiments, the volume fraction of the micropores is 5% to 50%, 10% to 50%, 15% to 50%, 20% to 50%, 25% to 50%, 30% to 50%, 25% to 50%, 40% to 50%, 5% to 45%, 10% to 45%, 15% to 45%, 20% to 45%, 25% to 45%, 30% to 45%, 25% to 45%, 5% to 25%, 10% to 25%, 15% to 25%, 20% to 25%, 5% to 15%, or 10% to 15%, relative to the volume of the mesopores, including any range therebetween. Each possibility represents a separate embodiment of the invention.

In some embodiments, microporosity is introduced in the composition by the metal doping. In some embodiments, the metal ions oxidize the carbon material. In some embodiments, mesoporosity is introduced in the composition through self-templating. In some embodiments, the composition comprises a hierarchical pore structure. In some embodiments, the hierarchical pore structure exposes the active sites of the composition allowing a better flow of reagents and products.

In some embodiments, porous carbon material is doped with 0.2 at. % to 5 at. %, 0.5 at. % to 5 at. %, 0.9 at. % to 5 at. %, 1.0 at. % to 5 at. %, 1.5 at. % to 5 at. %, 1.9 at. % to 5 at. %, 2 at. % to 5 at. %, 2.5 at. % to 5 at. %, 2.9 at. % to 5 at. %, 3 at. % to 5 at. %, 3.5 at. % to 5 at. %, 0.2 at. % to 4 at. %, 0.5 at. % to 4 at. %, 0.9 at. % to 4 at. %, 1.0 at. % to 4 at. %, 1.5 at. % to 4 at. %, 1.9 at. % to 4 at. %, 2 at. % to 4 at. %, 2.5 at. % to 4 at. %, 2.9 at. % to 4 at. %, 3 at. % to 4 at. %, 3.5 at. % to 4 at. %, 0.2 at. % to 3 at. %, 0.5 at. % to 3 at. %, 0.9 at. % to 3 at. %, 1.0 at. % to 3 at. %, 1.5 at. % to 3 at. %, 1.9 at. % to 3 at. %, 2 at. % to 3 at. %, or 2.5 at. % to 3 at. %, nitrogen, including any range therebetween. Each possibility represents a separate embodiment of the invention.

In some embodiments, the nitrogen is present in pyridinic form, pyrrolic form, pyrimidonic form, graphitic form metal-bound form, oxidized form, or any combination thereof. In some embodiments, the nitrogen is covalently bound. In some embodiments, the nitrogen is present in graphitic (N_{g}) form, pyridinic (Nₚ) form, pyrrolic (N_{py}) form, oxidized (Nₒₓ) form, or any combination thereof.

In some embodiments, the composition comprises a porous carbon material comprising mesopores, micropores, macropores, or any combination thereof, wherein the pores are void.

In some embodiments, the composition comprises a porous carbon material comprising mesopores, micropores, macropores, or any combination thereof, wherein the pores comprise an alkaline earth metal compound comprising magnesium, calcium, strontium, barium, or any combination thereof. In some embodiments, the earth metal compound is in the form of nanoparticles. In some embodiments, the nanoparticles are characterized by a diameter in the range of 1 nm to 60 nm, 2 nm to 60 nm, 5 nm to 60 nm, 6 nm to 60 nm, 7 nm to 60 nm, 8 nm to 60 nm, 9 nm to 60 nm, 10 nm to 60 nm, 15 nm to 60 nm, 20 nm to 60 nm, 25 nm to 60 nm, 30 nm to 60 nm, 35 nm to 60 nm, 1 nm to 50 nm, 2 nm to 50 nm, 5 nm to 50 nm, 6 nm to 50 nm, 7 nm to 50 nm, 8 nm to 50 nm, 9 nm to 50 nm, 10 nm to 50 nm, 15 nm to 50 nm, 20 nm to 50 nm, 25 nm to 50 nm, 30 nm to 50 nm, 35 nm to 50 nm, 5 nm to 45 nm, 6 nm to 45 nm, 7 nm to 45 nm, 8 nm to 45 nm, 9 nm to 45 nm, 10 nm to 45 nm, 15 nm to 45 nm, 20 nm to 45 nm, 25 nm to 45 nm, 30 nm to 45 nm, 35 nm to 45 nm, 5 nm to 40 nm, 6 nm to 40 nm, 7 nm to 40 nm, 8 nm to 40 nm, 9 nm to 40 nm, 10 nm to 40 nm, 15 nm to 40 nm, 20 nm to 40 nm, 25 nm to 40 nm, 30 nm to 40 nm, 35 nm to 40 nm, 5 nm to 35 nm, 6 nm to 35 nm, 7 nm to 35 nm, 8 nm to 35 nm, 9 nm to 35 nm, 10 nm to 35 nm, 15 nm to 35 nm, 20 nm to 35 nm, 25 nm to 35 nm, 5 nm to 20 nm, 6 nm to 20 nm, 7 nm to 20 nm, 8 nm to 20 nm, 9 nm to 20 nm, or 10 nm to 20 nm, including any range therebetween. Each possibility represents a separate embodiment of the invention. In some embodiments, the nanoparticles are characterized by a size in the range of 1 nm to 60 nm, 2 nm to 60 nm, 5 nm to 60 nm, 6 nm to 60 nm, 7 nm to 60 nm, 8 nm to 60 nm, 9 nm to 60 nm, 10 nm to 60 nm, 15 nm to 60 nm, 20 nm to 60 nm, 25 nm to 60 nm, 30 nm to 60 nm, 35 nm to 60 nm, 1 nm to 50 nm, 2 nm to 50 nm, 5 nm to 50 nm, 6 nm to 50 nm, 7 nm to 50 nm, 8 nm to 50 nm, 9 nm to 50 nm, 10 nm to 50 nm, 15 nm to 50 nm, 20 nm to 50 nm, 25 nm to 50 nm, 30 nm to 50 nm, 35 nm to 50 nm, 5 nm to 45 nm, 6 nm to 45 nm, 7 nm to 45 nm, 8 nm to 45 nm, 9 nm to 45 nm, 10 nm to 45 nm, 15 nm to 45 nm, 20 nm to 45 nm, 25 nm to 45 nm, 30 nm to 45 nm, 35 nm to 45 nm, 5 nm to 40 nm, 6 nm to 40 nm, 7 nm to 40 nm, 8 nm to 40 nm, 9 nm to 40 nm, 10 nm to 40 nm, 15 nm to 40 nm, 20 nm to 40 nm, 25 nm to 40 nm, 30 nm to 40 nm, 35 nm to 40 nm, 5 nm to 35 nm, 6 nm to 35 nm, 7 nm to 35 nm, 8 nm to 35 nm, 9 nm to 35 nm, 10 nm to 35 nm, 15 nm to 35 nm, 20 nm to 35 nm, 25 nm to 35 nm, 5 nm to 20 nm, 6 nm to 20 nm, 7 nm to 20 nm, 8 nm to 20 nm, 9 nm to 20 nm, or 10 nm to 20 nm, including any range therebetween. Each possibility represents a separate embodiment of the invention.

In some embodiments, the composition comprises a porous carbon material and a plurality of embedded nanoparticles. In some embodiments, the nanoparticles are discrete. In some embodiments, the nanoparticles are agglomerated. In some embodiments, the agglomerates are ordered. In some embodiments, the agglomerates are disordered. In some embodiments, the agglomerates are spherical. In some embodiments, the agglomerates are characterized by a size in the range of 1 s to 300 s of nm, 3 s to 300 s of nm, 4 s to 300 s of nm, 5 s to 300 s of nm, 9 s to 300 s of nm, 10 s to 300 s of nm, 1 s to 250 s of nm, 3 s to 250 s of nm, 4 s to 250 s of nm, 5 s to 250 s of nm, 9 s to 250 s of nm, 10 s to 250 s of nm, 1 s to 120 s of nm, 3 s to 120 s of nm, 4 s to 120 s of nm, 5 s to 120 s of nm, 9 s to 120 s of nm, 10 s to 120 s of nm, including any range therebetween. Each possibility represents a separate embodiment of the invention.

Herein throughout, the terms “nanoparticles”, “nanoparticle”, “nano”, “nanosized”, and any grammatical derivative thereof, which are used herein interchangeably, describe a particle featuring a size of at least one dimension thereof (e.g., diameter, length) that ranges from about 1 nanometer to 100 nanometers. Herein throughout, “NP(s)” designates nanoparticle(s).

In some embodiments, the size of the particles described herein represents an average or median size of a plurality of nanoparticle composites or nanoparticles.

In some embodiments, the average or the median size of at least e.g., 10%, 20%, 30%, 40%, 50%, 60%, 70%, 80%, 90%, or 95% of the particles, ranges from: about 1 nanometer to 1000 nanometers, or, in other embodiments from 1 nm to 500 nm, or, in other embodiments, from 5 nm to 200 nm. In some embodiments, the average or the median size ranges from about 1 nanometer to about 300 nanometers. In some embodiments, the average or the median size ranges from about 1 nanometer to about 200 nanometers. In some embodiments, the average or the median size ranges from about 1 nanometer to about 100 nanometers. In some embodiments, the average or the median size ranges from about 1 nanometer to 50 nanometers, and in some embodiments, it is lower than 35 nm.

In some embodiments, a plurality of the particles has a uniform size.

By “uniform” or “homogenous” it is meant to refer to size distribution that varies within a range of less than e.g., ±60%, ±50%, ±40%, ±30%, ±20%, or ±10%, including any value therebetween. Each possibility represents a separate embodiment of the invention.

In some embodiments, plurality of the particles is characterized by an average hydrodynamic diameter of less than 30 nm with a size distribution of that varies within a range of less than e.g., 60%, 50%, 40%, 30%, 20%, or 10%, including any value therebetween. Each possibility represents a separate embodiment of the invention.

In some embodiments, the particles size is about 1 nm, about 2 nm, about 3 nm, about 4 nm, about 5 nm, about 6 nm, about 7 nm, about 8 nm, about 9 nm, about 10 nm, about 11 nm, about 12 nm, about 13 nm, about 14 nm, about 15 nm, about 16 nm, about 17 nm, about 18 nm, about 19 nm, about 20 nm, about 21 nm, about 22 nm, about 23 nm, about 24 nm, about 25 nm, about 26 nm, about 27 nm, about 28 nm, about 29 nm, about 30 nm, about 31 nm, about 32 nm, about 33 nm, about 34 nm, about 35 nm, about 36 nm, about 37 nm, about 38 nm, about 40 nm, about 42 nm, about 44 nm, about 46 nm, about 48 nm, or 50 nm, including any value therebetween. Each possibility represents a separate embodiment of the invention.

As used herein the terms “average” or “median” size refer to diameter of the particles. The term “diameter” is art-recognized and is used herein to refer to either of the physical diameter (also termed “dry diameter”) or the hydrodynamic diameter. As used herein, the “hydrodynamic diameter” refers to a size determination for the composition in solution (e.g., aqueous solution) using any technique known in the art, e.g., dynamic light scattering (DLS).

As exemplified in the Example section that follows, the dry diameter of the particles, as prepared according to some embodiments of the invention, may be evaluated using transmission electron microscopy (TEM) or scanning electron microscopy (SEM) imaging.

The particle(s) can be generally shaped as a sphere, incomplete-sphere, particularly the size attached to the substrate, a rod, a cylinder, a ribbon, a sponge, and any other shape, or can be in a form of a cluster of any of these shapes, or can comprises a mixture of one or more shapes.

In some embodiments, the alkaline earth metal compound is characterized by crystallite size in the range of 3 nm to 40 nm, 4 nm to 40 nm, 5 nm to 40 nm, 10 nm to 40 nm, 15 nm to 40 nm, 20 nm to 40 nm, 3 nm to 30 nm, 4 nm to 30 nm, 5 nm to 30 nm, 10 nm to 30 nm, 15 nm to 30 nm, 20 nm to 30 nm, 3 nm to 20 nm, 4 nm to 20 nm, 5 nm to 20 nm, or 10 nm to 20 nm, including any range therebetween. Each possibility represents a separate embodiment of the invention.

In some embodiments, the composition comprises 60 at %. to 95 at %. carbon. In some embodiments, the composition comprises 60 at %. to 95 at., 65 at %. to 95 at %., 70 at %. to 95 at %., 80 at %. to 95 at %., 83 at %. to 95 at %., 85 at %. to 95 at %., 89 at %. to 95 at %., 60 at %. to 90 at %., 65 at %. to 90 at %., 70 at %. to 90 at %., 80 at %. to 90 at %., 83 at %. to 90 at %., 85 at %. to 90 at %., or 89 at %. to 90 at %., carbon, including any range therebetween. Each possibility represents a separate embodiment of the invention.

In some embodiments, the composition comprises a first alkaline earth metal. In some embodiments, the composition comprises a second alkaline earth metal. In some embodiments, the composition comprises a first alkaline earth metal, and optionally a second alkaline earth metal. In some embodiments, the first alkaline earth metal is selected from the group consisting of magnesium, calcium, strontium, barium, and radium. In some embodiments, the second alkaline earth metal is selected from the group consisting of magnesium, calcium, strontium, barium, radium, or any combination thereof. In some embodiments, the second alkaline earth metal is present at a concentration of 0.1% to 75%, 0.3% to 75%, 0.5% to 75%, 0.8% to 75%, 0.9% to 75%, 1% to 75%, 3% to 75%, 5% to 75%, 10% to 75%, 15% to 75%, 20% to 75%, 25% to 75%, 30% to 75%, 40% to 75%, 50% to 75%, 60% to 75%, 0.1% to 50%, 0.3% to 50%, 0.5% to 50%, 0.8% to 50%, 0.9% to 50%, 1% to 50%, 3% to 50%, 5% to 50%, 10% to 50%, 15% to 50%, 20% to 50%, 25% to 50%, 30% to 50%, 0.1% to 30%, 0.3% to 30%, 0.5% to 30%, 0.8% to 30%, 0.9% to 30%, 1% to 30%, 3% to 30%, 5% to 30%, 10% to 30%, 15% to 30%, 20% to 30%, 0.1% to 10%, 0.3% to 10%, 0.5% to 10%, 0.8% to 10%, 0.9% to 10%, 1% to 10%, 3% to 10%, or 5% to 10%, relative to the first alkaline earth metal, including any range therebetween. Each possibility represents a separate embodiment of the invention.

In some embodiments, the composition comprises an alkaline earth metal in its elemental form. In some embodiments, the composition comprises alkaline earth metals resulting from reduction by the carbon material matrix. In some embodiments, an alkaline earth metal is discretely dispersed in the carbon matrix. In some embodiments, an alkaline earth metal is agglomerated in the carbon matrix.

One of skill in the art will appreciate that the order of the metals may be altered in various embodiments and that the nomenclature “first alkaline earth metal” and “second alkaline earth metal” is used herein for ease of reference.

In some embodiments, the composition is for use in hydrazine oxidation reaction (HzOR), oxygen reduction reaction (ORR), or both.

In some embodiments, the composition is a catalyst. As used herein, the term “catalyst” refers to a substance which alters the rate of a chemical reaction. Catalysts participate in a reaction in a cyclic fashion such that the catalyst is cyclically regenerated. In some embodiments, the catalyst is for use in hydrazine oxidation reaction (HzOR). In some embodiments, the catalyst is for use in oxygen reduction reaction (ORR). In some embodiments, the catalyst is configured to oxidize hydrazine in solutions with a pH ranging from 0 to 14 with good to excellent activity.

In some embodiments, the catalyst is characterized by a faradaic efficiency in the range of 50% to 100%, 55% to 100%, 60% to 100%, 65% to 100%, 70% to 100%, 75% to 100%, 80% to 100%, 85% to 100%, 50% to 98%, 55% to 98%, 60% to 98%, 65% to 98%, 70% to 98%, 75% to 98%, 80% to 98%, 85% to 98%, 50% to 95%, 55% to 95%, 60% to 95%, 65% to 95%, 70% to 95%, 75% to 95%, 80% to 95%, 85% to 95%, 50% to 85%, 55% to 85%, 60% to 85%, 65% to 85%, 70% to 85%, 75% to 85%, or 80% to 85%, including any range therebetween. Each possibility represents a separate embodiment of the invention.

In some embodiments, the catalyst is stable for at least 2000 cycles, at least 2500 cycles, at least 3000 cycles, at least 3500 cycles, at least 4000 cycles, at least 4500 cycles, at least 5000 cycles, at least 10000 cycles, or at least 15000 cycles, as measured by CV, including any value therebetween. Each possibility represents a separate embodiment of the invention.

In some embodiments, the electrochemical cell is stable for 2000 cycles to 50000 cycles, 2500 cycles to 50000 cycles, 5000 cycles to 50000 cycles, 9000 cycles to 50000 cycles, 10000 cycles to 50000 cycles, 15000 cycles to 50000 cycles, 20000 cycles to 50000 cycles, 25000 cycles to 50000 cycles, 35000 cycles to 50000 cycles, 2500 cycles to 50000 cycles, or 5000 cycles to 9000 cycles, as measured by CV, including any range therebetween. Each possibility represents a separate embodiment of the invention.

According to some embodiments, the present invention provides an article comprising a composition as described herein. In some embodiments, the composition is deposited on at least one surface of the article. In some embodiments, the article is in the form of an anode.

In some embodiments, the loading of the composition is in the range of 0.01 mg cm⁻² to 0.3 mg cm⁻², 0.02 mg cm⁻² to 0.3 mg cm⁻², 0.03 mg cm⁻² to 0.3 mg cm⁻², 0.05 mg cm⁻² to 0.3 mg cm⁻², 0.09 mg cm⁻² to 0.3 mg cm⁻², 0.1 mg cm⁻² to 0.3 mg cm⁻², 0.01 mg cm⁻² to 0.2 mg cm⁻², 0.02 mg cm⁻² to 0.2 mg cm⁻², 0.02 mg cm⁻² to 0.2 mg cm⁻², 0.05 mg cm⁻² to 0.2 mg cm⁻², 0.09 mg cm⁻² to 0.2 mg cm⁻², 0.1 mg cm⁻² to 0.2 mg cm⁻², 0.01 mg cm⁻² to 0.1 mg cm⁻², 0.02 mg cm⁻² to 0.1 mg cm⁻², or 0.03 mg cm² to 0.1 mg cm⁻², including any range therebetween. Each possibility represents a separate embodiment of the invention.

According to some embodiments, the present invention provides an electrochemical cell comprising the article described herein. In some embodiments, the electrochemical cell is configured to oxidize hydrazine at onset potentials in the range of 0.20 V vs. reversible hydrogen electrode (RHE) to 0.8 V vs. RHE.

In some embodiments, the onset potentials is pH depended. In some embodiments, the electrochemical cell comprising the article described herein is configured to oxidize hydrazine in solutions with a pH ranging from 0 to 14 with good to excellent activity.

### The Process

According to some embodiments, the present invention provides a process of oxidizing hydrazine. In some embodiments, the process comprises contacting a hydrazine containing solution with the electrochemical cell described herein, and applying an anodic electric potential to the electrochemical cell, thereby oxidizing the hydrazine.

In some embodiments, the solution comprises an electrolyte selected from sodium hydroxide (NaOH) solution, potassium hydroxide (KOH) solution, lithium hydroxide (LiOH) solution, phosphate-buffered saline (PBS) solution, sulfuric acid (H₂SO₄), perchloric acid (HClO₄) or any combination thereof. In some embodiments, the concentration of the electrolyte in the solution is 0.01 M to 5 M, 0.02 M to 5 M, 0.05 M to 5 M, 0.09 M to 5 M, 0.1 M to 5 M, 0.5 M to 5 M, 0.9 M to 5 M, 1M to 5M, 2M to 5M, 3 M to 5 M, 4 M to 5 M, 0.01 M to 4.5 M, 0.02 M to 4.5 M, 0.05 M to 4.5 M, 0.09 M to 4.5 M, 0.1 M to 4.5 M, 0.5 M to 4.5 M, 0.9 M to 4.5 M, 1M to 4.5M, 2M to 4.5M, 3M to 4.5 M, 0.01 M to 2.5 M, 0.02 M to 2.5 M, 0.05 M to 2.5 M, 0.09 M to 2.5 M, 0.1 M to 2.5 M, 0.5M to 2.5M, 0.9M to 2.5M, 1M to 2.5M, 2M to 2.5M, 0.01M to 1M, 0.02M to 1M, 0.05M to 1M, 0.09M to 1M, 0.1M to 1M, 0.5M to 1M, or 0.9M to 1M, including any range therebetween.

In some embodiments, the solution has a pH of 0 to 14, 1 to 14, 2 to 14, 3 to 14, 4 to 14, 5 to 14, 6 to 14, 7 to 14, 8 to 14, 0 to 12, 1 to 12, 2 to 12, 3 to 12, 4 to 12, 5 to 12, 6 to 12, 7 to 12, 8 to 12, 0 to 8, 1 to 8, 2 to 8, 3 to 8, 4 to 8, 5 to 8, 6 to 8, 7 to 8, 0 to 6, 1 to 6, 2 to 6, 3 to 6, or 4 to 6, including any range therebetween.

In some embodiments, the process is performed at a temperature of 20° C. to 95° C., 23° C. to 55° C., 25° C. to 55° C., 30° C. to 55° C., 32° C. to 55° C., 35° C. to 55° C., 40° C. to 55° C., 20° C. to 45° C., 23° C. to 45° C., 25° C. to 45° C., 30° C. to 45° C., 32° C. to 45° C., 35° C. to 45° C., 40° C. to 45° C., 20° C. to 35° C., 23° C. to 35° C., 25° C. to 35° C., 45° C. to 95° C., 35° C. to 85° C., 60° C. to 90° C. or 30° C. to 35° C., including any range therebetween.

In some embodiments, the process is characterized by a faradaic efficiency in the range of 50% to 100%, 55% to 100%, 60% to 100%, 65% to 100%, 70% to 100%, 75% to 100%, 80% to 100%, 85% to 100%, 50% to 98%, 55% to 98%, 60% to 98%, 65% to 98%, 70% to 98%, 75% to 98%, 80% to 98%, 85% to 98%, 50% to 95%, 55% to 95%, 60% to 95%, 65% to 95%, 70% to 95%, 75% to 95%, 80% to 95%, 85% to 95%, 50% to 85%, 55% to 85%, 60% to 85%, 65% to 85%, 70% to 85%, 75% to 85%, or 80% to 85%, including any range therebetween.

In some embodiments, the electrochemical cell is stable for at least 2000 cycles, at least 2500 cycles, at least 3000 cycles, at least 3500 cycles, at least 4000 cycles, at least 4500 cycles, at least 5000 cycles, at least 10000 cycles, or at least 15000 cycles, as measured by CV, including any value therebetween.

In some embodiments, the electrochemical cell is stable for 2000 cycles to 50000 cycles, 2500 cycles to 50000 cycles, 5000 cycles to 50000 cycles, 9000 cycles to 50000 cycles, 10000 cycles to 50000 cycles, 15000 cycles to 50000 cycles, 20000 cycles to 50000 cycles, 25000 cycles to 50000 cycles, 35000 cycles to 50000 cycles, 2500 cycles to 50000 cycles, or 5000 cycles to 9000 cycles, as measured by CV, including any range therebetween.

### The Method

According to some embodiments, the present invention provides a method for making a templated porous carbon material with hierarchical porosity.

In some embodiments, the method comprises: providing one or more earth metal-coordination polymer precursor comprising magnesium, calcium, strontium, barium, or any combination thereof, and pyrolysing the earth metal-coordination polymer precursor, thereby obtaining the porous carbon material. In some embodiments, the carbon material comprises a carbon matrix doped with nitrogen atoms and comprising embedded inorganic nanoparticles comprising an earth metal compound comprising magnesium, calcium, strontium, barium, or any combination thereof. In some embodiments, the composition is formed by a self-templating mechanism. In some embodiments, the nanoparticles are spontaneously formed, and template micropores, mesopores and/or macropores in the carbon material.

In some embodiments, the porosity and characteristics of the obtained porous carbon material can be tuned by choosing an appropriate metal-organic coordination polymer (MOCP).

In some embodiments, the MOCP comprises a Group 2 metal. In some embodiments, the MOCP are based on Mg²⁺, Ca²⁺, Sr²⁺ or Ba²⁺, and nitrilotriacetic acid (H₃NTA), as ligand. In some embodiments, the MOCP is characterized by a formula M(NTA)₃, wherein M is a Group 2 metal.

In some embodiments, the MOCP serve as both a source and a spontaneous template for the final carbon material.

In some embodiments, during pyrolysis, the precursor ligand is carbonized, yielding a carbon matrix doped with nitrogen atoms and embedded with inorganic nanoparticles.

In some embodiments, the organic ligands of the MOCP are carbonized to yield a carbon matrix, doped by atomic or nanoparticulate metal sites. In some embodiments, inorganic particles form inside the carbon material. In some embodiments, the inorganic particles are oxide particles MO (e.g. MgO, CaO). In some embodiments, the inorganic particles are carbonate particles MCO₃ (e.g. SrCO₃, BaCO₃).

In some embodiments, the obtained inorganic/carbon composites are characterized by a formula MX@NC, wherein where M=Mg, Ca, Sr, Ba, and X=the anion(s). In some embodiments, inorganic particles are washed away, serving as in situ templates for meso-, micro- and macropores. In some embodiments, the final porous carbon material is characterized by a formula NC-M.

In some embodiments, pyrolysing comprises heating the composition in an inert atmosphere. In some embodiments, heating is at a temperature in the range of 450° C. to 1100° C., 450° C. to 1000° C., 500° C. to 1100° C., 800° C. to 1000° C., 600° C. to 900° C., 650° C. to 900° C., 700° C. to 900° C., 750° C. to 900° C., or 800° C. to 900° C., including any range therebetween.

In some embodiments, the inorganic particles formed during pyrolysis are temperature dependent. In some embodiments, the size of the inorganic particles formed during pyrolysis is temperature dependent.

In some embodiments, the method further comprises a third step of washing the doped earth metal carbon material. In some embodiments, the method further comprises a third step of washing the doped earth metal carbon material, thereby obtaining the porous carbon material. In some embodiments, the porous carbon material is devoid of inorganic particles. In some embodiments the inorganic particles are washed out. In some embodiments, the washing is done using an acid. In some embodiments, washing is with hydrochloric acid (HCl).

In some embodiments, the method further comprises a step of heating the washed porous carbon material at a temperature in the range of 900° C. to 1100° C., for a period of time between 45 minutes (min) and 3 hours (h).

In some embodiments, the conductivity of the porous carbon material is temperature dependent. In some embodiments, the surface area of the porous carbon material is temperature dependent. In some embodiments, the pore volume is temperature dependent. In some embodiments, the nitrogen content is temperature dependent. In some embodiments, conductivity, surface area, pore volume, or any combination thereof increases with temperature increase. In some embodiments, nitrogen content decreases with temperature increase.

### General

As used herein the term “about” refers to ±10%.

The terms “comprises”, “comprising”, “includes”, “including”, “having” and their conjugates mean “including but not limited to”.

The term “consisting of means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

As used herein, the term “treating” includes abrogating, substantially inhibiting, slowing or reversing the progression of a condition, substantially ameliorating clinical or aesthetical symptoms of a condition or substantially preventing the appearance of clinical or aesthetical symptoms of a condition.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

Reference is now made to the following examples, which together with the above descriptions illustrate some embodiments of the invention in a non-limiting fashion.

### Example 1

### Self-Templating Design of Hierarchical Porosity Using Barium Carbonate Nanoparticles

### Material and Methods

### Precursor Synthesis

The Ba-NTA metal coordination polymer was prepared as reported earlier. Briefly, 22.93 gr (120 mmol) of nitrilotriacetic acid (N(CH₂COOH)₃, H₃NTA) were added to 300 mL DI water at 85° C., followed by 18.95 gr (96 mmol) of BaCO₃ and 7.57 gr (24 mmol) of Ba(OH)₂.8H₂O. A white precipitate formed; to complete precipitation, the beaker was placed in an ice bath after 15 minutes, and 1.5 L of ethanol were added. The final precipitate was filtered and vacuum-dried at 50° C. for three days.

### Carbon Synthesis

5 gr of Ba-NTA were placed in a quartz boat inside a tube furnace under a flow of argon (150 cm³ min⁻¹). The sample was heated to 70° C. for 3 hours, then heated to temperature T at 10° C. min⁻¹, soaked at T for 1 hour, then allowed to cool naturally. The resulting black powder was stirred with 100 mL of 1 M hydrochloric acid for 72 hours, filtered, washed with 800 mL DI water, and vacuum-dried at 50° C. overnight. The washed carbon was annealed again in argon at 1000° C. (dwell time 1 hr, heating rate 5° C. min⁻¹).

### Material Characterizations

Thermal gravimetric analysis (TGA) coupled with differential scanning calorimetry (DSC) was performed in a Netzch Jupiter® STA 449F3 instrument, under argon flow (20 mL min⁻¹). X-ray diffraction (XRD) was carried out on a powder X-ray diffractometer (Rigaku, SmartLab). Scherrer analysis of the sizes of coherently scattering domains was performed using the PDXL software. High resolution scanning electron microscopy (HR-SEM) was done on a Zeiss Ultra+ microscope, using an accelerating voltage of 4 keV. Transmission electron microscopy (TEM) was conducted using FEI Tecnai G2 T20 S-Twin TEM instrument, using an accelerating voltage of 200 keV. N₂ adsorption-desorption isotherms at 77 K were measured on a Quantachrome Autosorb iQ instrument, using vacuum-dried samples (200° C. for 10 h⁻¹). The isotherms were analyzed using the Brunauer-Emmett-Teller (BET) model for specific surface area, and quenched solid state density functional theory (QSDFT) isotherm fitting for meso-micropore size distribution. In the latter, the model used was N₂/carbon at 77 K, with slit-shaped pores, in equilibrium. X-Ray photoelectron spectroscopy (XPS) measurements were carried out using a PHI VersaProbe III scanning XPS microprobe (Physical Instruments AG). Analysis was performed using a monochromatic Al K_{α} X-ray source of 1486.6 eV, with a beam size of 200 μm. Survey spectra were recorded with a pass energy of 140 eV (step size 0.5 eV), and surface concentrations of the elements were calculated by peak integration. The core level binding energies of the different peaks were normalized by setting the binding energy for the C is peak at 285.0 eV. The atomic concentrations were calculated using elemental sensitivity factors without applying any standardization procedure. Curve fitting was done using CasaXPS 2.3.19PR1.0. Elemental analysis was performed using Flash 2000 Organic Elemental Analyzer (Thermo Scientific) at 950° C., on 2-3 mg of sample in a tin crucible, with 8-10 mg of vanadium as a combustion aid (except for the C-700 sample, where vanadium was not employed). Raman spectroscopy was performed on a LabRam micro-Raman instrument with 532 nm laser excitation, 1800 grating, two acquisitions of 50 seconds each. The spectra were fit with four components, based on literature assignments. The in-plane (a direction) lengths of graphitic crystallites (Lₐ) were calculated from the intensity ratios of fitted D and G bands, according to the relation determined by Cangado et al.

### Procedure for Electrochemical Measurements

Inks of the carbon powders (0.80 mL DI water, 0.20 mL ethanol, 10 μL Nafion® 5 wt % dispersion (Alfa Aesar), 1.0 mg carbon powder) were sonicated and dropcast (20 μL) on a polished glassy carbon electrode (5 mm diameter) and dried at 50° C. Total catalyst loading was 0.02 mg, or 0.1 mg cm². Electrochemical experiments were performed in 1 M KOH at 25.0±0.1° C., using a BioLogic VSP multichannel potentiostat. Saturated calomel electrode (SCE), separated by a 10 mm frit was used as a reference electrode, and a graphite rod as a counter electrode. Potentials were reported vs. reversible hydrogen electrode (RHE) by adding 1.0708 for pH 14. N₂ (99.999%) was bubbled for >30 min, and was flowed above the solution during the experiments. Measurements were carried out in 10 mM of hydrazine unless stated otherwise. Cyclic voltammograms (CVs) were collected from 0.17 V to 1.17 V vs. RHE with a scan rate of 10 mV s⁻¹. Rotating disk electrode (RDE) voltammograms were collected at rotating speed of 1600 rpm. A positive feedback automatic iR correction of 80% was used, with an AV amplitude of 5 mV. Before measurements, the electrode was cycled between 0.1708 and 0.4708 V vs. RHE for 20 cycles at 100 mV s⁻¹ to reduce surface-adsorbed oxygen and improve wetting. Electrochemical surface area (ECSA) was calculated from the non-faradaic charging current, as determined from CV cycles at 8 scan rates (2, 5, 10, 15, 20, 40, 60 mV s⁻¹) at a small potential window of 0.1708 V to 0.4708 V (vs. RHE) in 1 M KOH:

$${A}_{ECSA} = \frac{sp . capacitance}{40 μ F {cm}^{- 2}}$$

This calculation assumes a reasonable value of 40 μF cm⁻² for the surface-area normalized capacitance associated with double-layer charging.

### Results and Discussion

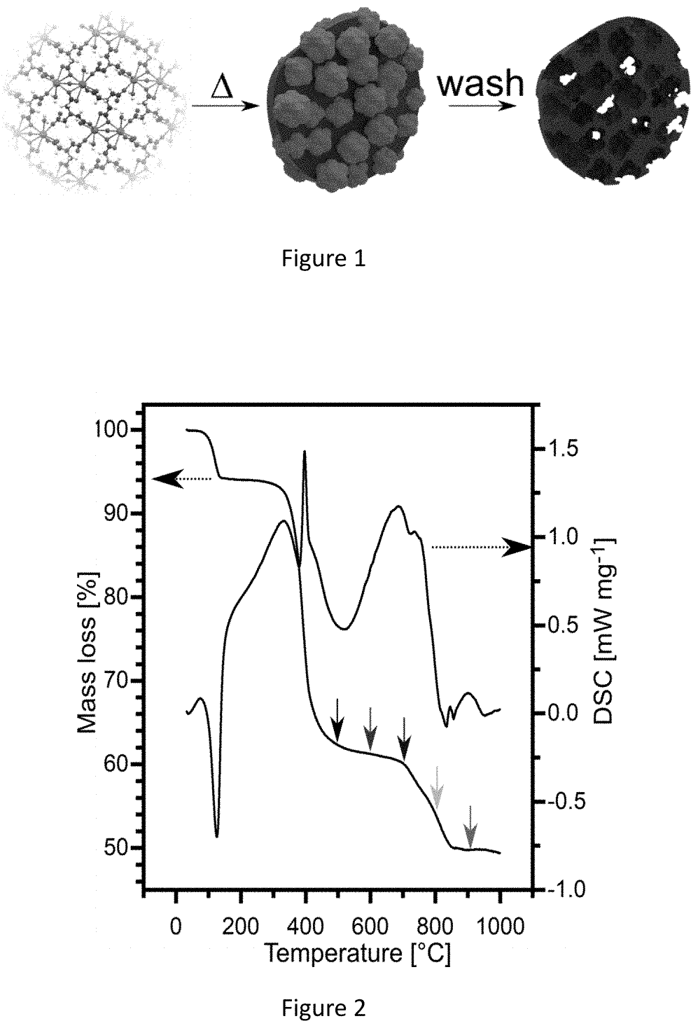

The preparation of the various N-doped self-templating carbons proceeds according to a three-step procedure (FIG. 1). First, barium nitrilotriacetate (Ba-NTA), a well-defined metal coordination polymer, was pyrolyzed in argon at a range of temperatures. The resulting powder was a composite between barium-based inorganic nanoparticles, and an N-doped carbon matrix. These composites were denoted BaC-T, where T is the pyrolysis temperature. Then, the inorganic particles were washed out with HCl, yielding a flow-enabling meso- and macro-porous structure. Finally, the washed carbon was heat treated again at 1000° C. in argon, to promote graphitization and clear the micropores (carbons “C-T”).

To study the self-templating process by Ba²⁺ ions, the inventors chose a range of temperatures where Ba-based particles may exist and vary in size and crystal phase. Thermal gravimetric analysis (TGA) provides charts the course of the pyrolytic synthesis (FIG. 2). According to Naik and Budkuley, BaCO₃ starts forming at 400° C.; the earlier mass loss events correspond to dehydration (100° C.) and ligand carbonization (350-500° C.). At higher temperatures, the carbonate was transformed to BaO, while the carbon was being driven away as CO₂. Thus, the inventors chose 500, 600, and 700° C. as pyrolysis temperatures in the carbonate range, and 800 and 900° C. to represent two stages of the final transformation. Composites BaC-500 to BaC-800 were black powders, while BaC-900 was nearly white and dissolved entirely by the acid. Thus, assuming the final product was BaO, the carbon yields are 19% (BaC-500), 18% (BaC-600), 16% (BaC-700) and 9% (BaC-800).

### Composition and Structure of the Self-Templating Inorganic Particles

To understand the evolution of inorganic particles inside the carbon matrix—and thus, their templating role in the nanostructure of the final catalyst—the inventors analyzed the crystalline phases by X-ray diffraction (XRD). BaC-500 contains a rare, lattice-substituted δ-BaCO₃ phase. This meta-stable phase forms when small inorganic oxide molecules (e.g. SO₄²⁻, CrO₄²⁻) substitute a γ-BaCO₃ lattice. Interestingly, barium acetate forms from BaNTA at 320° C., immediately before BaCO₃ formation. Thus, the inventors propose that at these low pyrolysis temperature, acetate occupies lattice positions, yielding the unique lattice-substituted δ-BaCO₃ phase. At higher temperatures, the lattice substituents were released, leaving behind a pure γ-BaCO₃ (witherite) in BaC-600 and BaC-700. The γ-BaCO₃ phase undergoes a phase transition at 811° C. (under standard conditions) to yield α-BaCO₃. However, this phase was unquenchable, and couldn't be observed at room temperature. Rather, Ba(OH)₂ peaks appeared in BaC-800, growing further in BaC-900. These peaks reflect the continuous CO₂ removal from the carbonate.

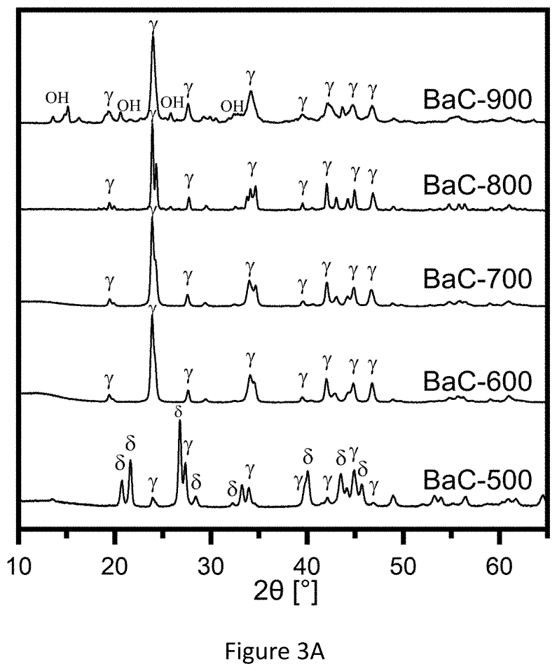

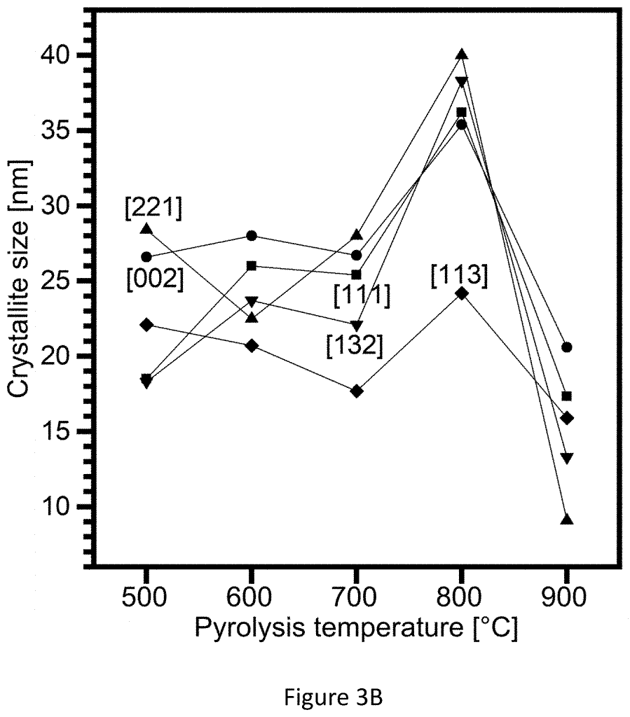

Sizes of the crystalline particles are traditionally estimated by Scherrer analysis, which correlates peak broadening to quantum effects visible on the nanoscale. By following several diffraction peaks at each pyrolysis temperature, the inventors could obtain reliable information on their broadening. Importantly, this analysis determines the size of coherently scattering crystallites, rather than ‘particle size’. Such crystallites are often smaller than the entire nanoparticle, due to the presence of various defects. In the BaCO₃-carbon composites studied, the crystalline domains were 20-30 nm in size along four different lattice directions (FIG. 3B). These values are constant between 500 and 700° C. In BaC-800, near the phase temperature, they rise by 5-10 nm. Interestingly, their size appears to drop dramatically in BaC-900, down to 10-20 nm. However, this apparent decrease can be assigned to the γ-BaCO₃ [symbol] α-BaCO₃ phase transition, which necessarily introduces crystal defects—rather than to an actual decrease in particle size.

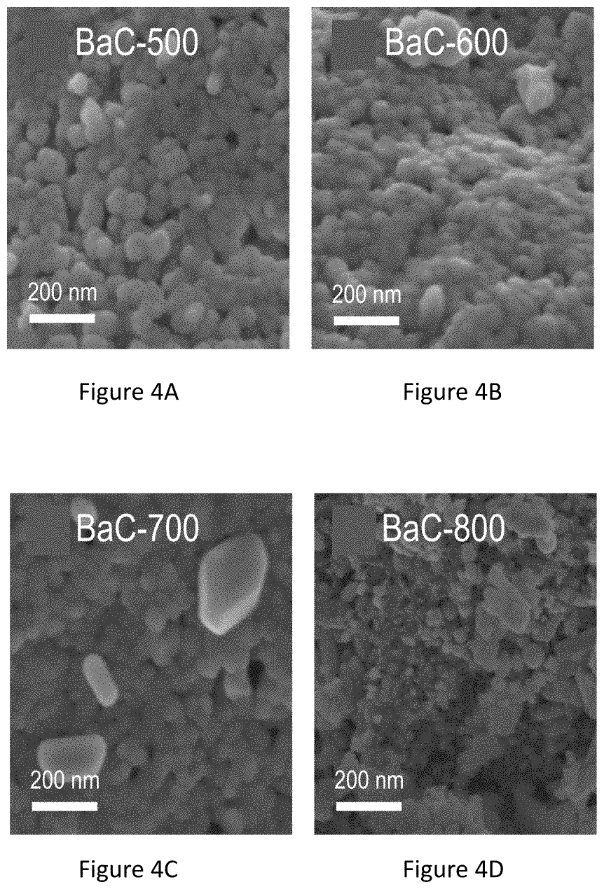

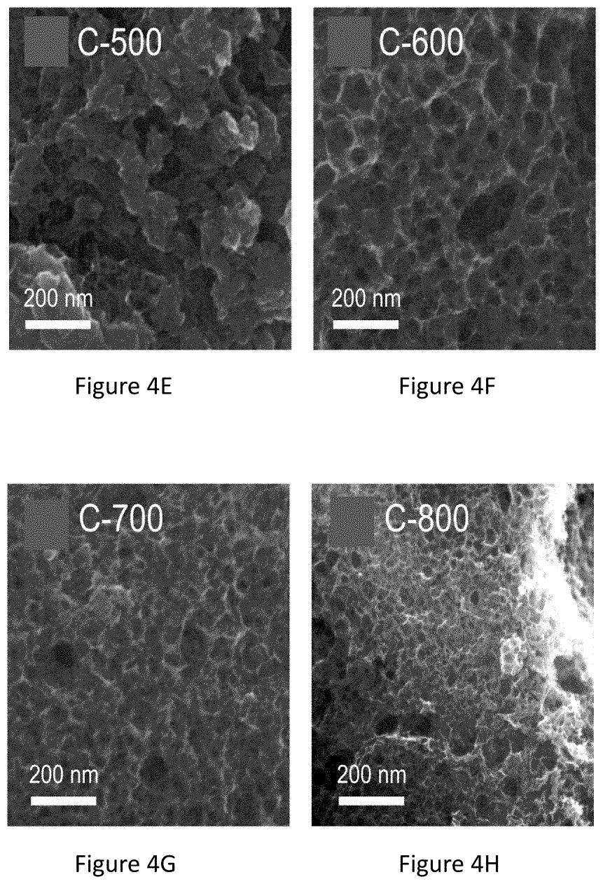

Sizes and shapes of the inorganic nanoparticles were analyzed by high resolution scanning electron microscopy (HR-SEM), revealing densely packed BaCO₃ particles in the BaC-T composites (FIGS. 4A-D). Most aggregates were 20-60 nm in size, in agreement with the values estimated in the Scherrer analysis. These particles seem to shrink with rising temperatures, while large micron-sized, faceted crystals appear. The smaller particles also become better annealed (less defective) at higher temperatures, as seen in the narrowing of X-ray peaks due to growth of coherently scattering domains (FIG. 3B).

In the final, BaCO₃-free carbons, HR-SEM reveals a developed, near-organized nanostructure (FIG. 4E-H). The porosity is highly open, and visibly hierarchical—a crucial feature for enabling flow during catalysis. Importantly, the meso- and macro-pores match the BaCO₃ particles in the pre-washed composite material (in size, shape, and spatial distribution). The diminishing mesopores match the shrinking BaCO₃ particles, confirming the identity of these nanoparticles as pore templates. This proves that BaNTA is an excellent self-templating precursor, yielding N-doped carbons with tunable mesoporosity.

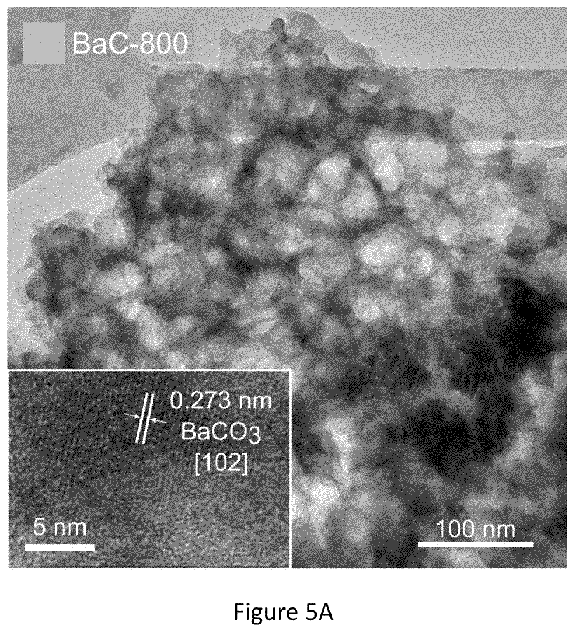

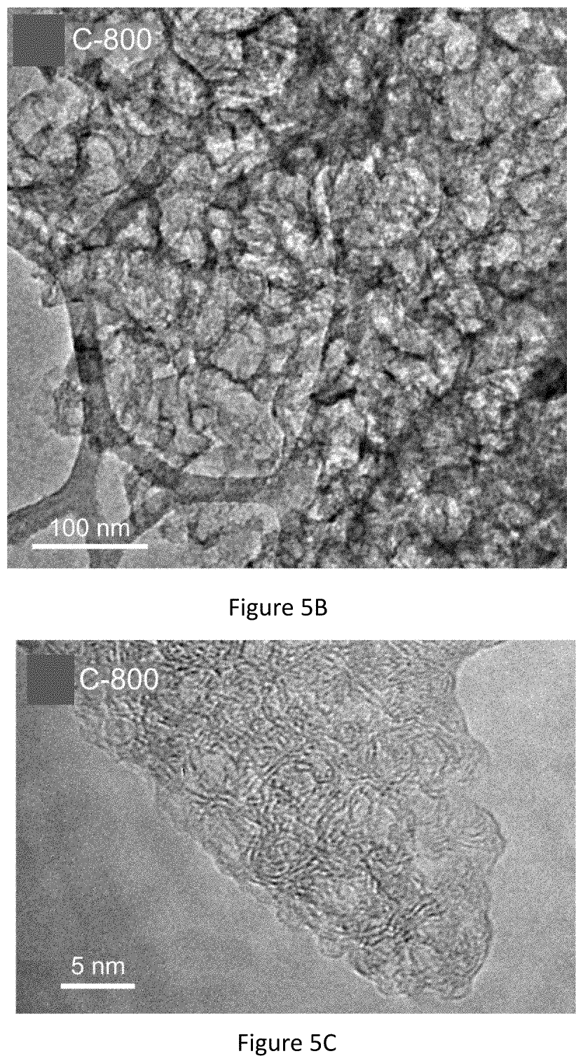

The carbon with the finest mesopores (C-800) was further analyzed by transmission electron microscopy (TEM, FIGS. 5A-C), before and after removal of the BaCO₃ templates. In BaC-800, BaCO₃ particles (identified by their lattice spacing) were agglomerated into similarly sized, densely-packed aggregates. After washing, C-800 exhibited a highly graphitized carbon structure, with open and hierarchical porosity (FIG. 5B). Some barium carbonate particles remained despite the washing, protected from the acid by the carbon sheath. The smallest mesopores were revealed in the TEM micrograph to be folds and interstices in between sheets of crumpled multi-layer graphene (FIG. 5C). The high degree of graphitization, combined with the open and structured porosity, were expected to benefit mass transfer during electrocatalysis.

### Composition and Structure of the Hierarchically Porous Carbons

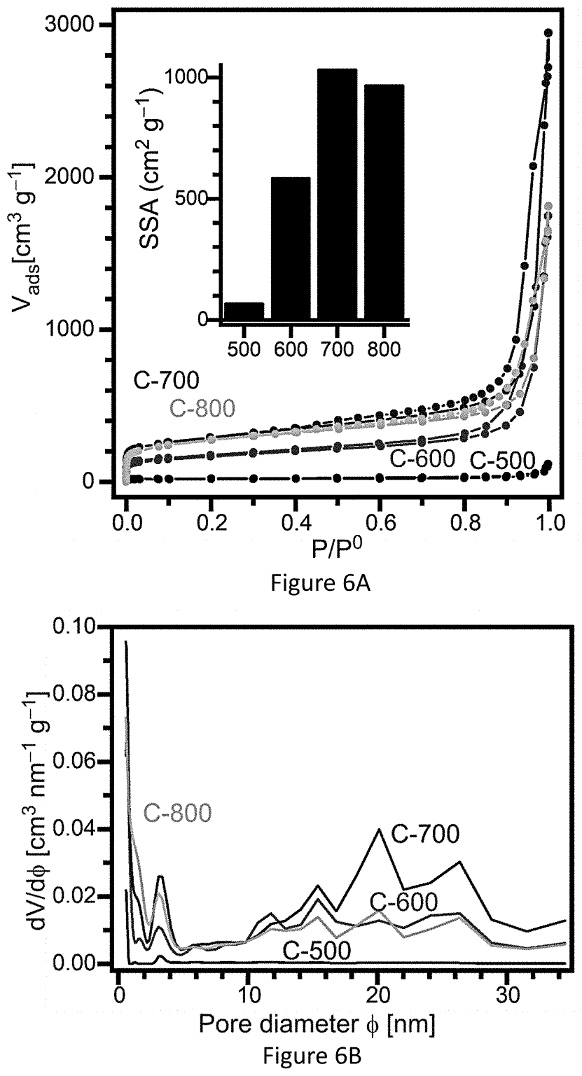

To determine the specific surface area (SSA) and the pore size distribution—crucial parameters in determining active site exposure and mass transfer—the inventors measured the physisorption of N₂ on the different carbons (FIGS. 6A-B). The BET-calculated SSAs peak at 1030 m² gr⁻¹ for C-700 (FIGS. 6A-B), with C-500 lower by an order of magnitude (70 m² gr⁻¹). The SSA correlates with monolayer adsorption, as seen in the steep initial rise in the isotherm. The final rise in all isotherms—particularly for that in C-700—indicate the onset of N₂ condensation in macropores. Quantitative pore size distribution was calculated by the advanced QSDFT model, revealing pores larger ˜20±10 nm in diameter for carbons pyrolyzed above 600° C. Some smaller pores (2-3 nm) are also seen in the distribution. The highest pore volume was measured for C-700, an enormous 4.6 mL gr⁻¹, out of which a full 4.3 mL g⁻¹ are due to meso- and macropores. Thus, C-700 was both highly microporous—suggesting high exposure of active sites—and offers exceptional possibilities for mass transfer in its meso- and macropores. At the lowest temperature, no mesopores were measured whatsoever, corroborating the HRSEM observations of larger macropores. In C-800 there was a slight (6%) drop in SSA relative to C-700, probably arising from the onset of micropore collapse with rising temperatures.

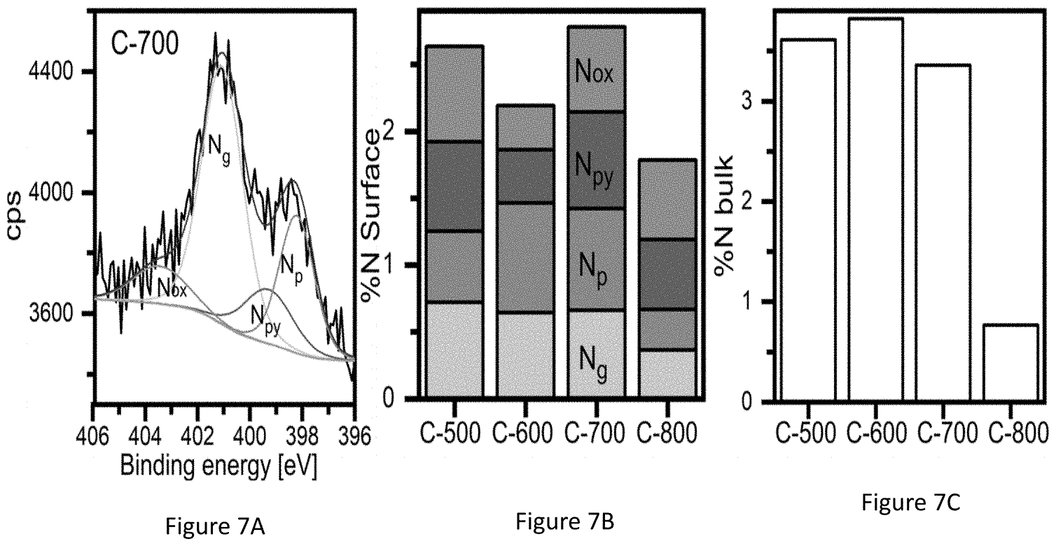

Doping plays a central part in carbon electrocatalysis, since dopants typically serve as active catalytic sites. Moreover, dopants such as nitrogen improve conductivity, wettability and modify the work function of the carbon. The inventors have quantified the nitrogen content both at the surface and in the bulk of the carbon, using X-ray photoelectron spectroscopy (XPS) and elemental analysis (FIGS. 7A-C). In the bulk, nitrogen content was stable around 3.5 at % between 500 and 700° C., then dropping rapidly to 0.8 at % in C-800. This decrease was correlated with the overall decomposition of the material (as observed by TGA, FIG. 2); the preferential loss of nitrogen has been documented before. Similarly, the nitrogen content at the surface is near 2.4 at %, as determined by the less-quantitative method of XPS survey integration; the drop in C-800 is milder, down to 1.9 at %. Deconvolution of high resolution XPS peaks revealed four nitrogen moieties (FIG. 7A): pyridinic (Nₚ), pyrrolic (N_{py}), graphitic (N_{g}) and oxidized (Nₒₓ). In all four carbons, these nitrogen types exist in a roughly constant ratio, varying without apparent trend. Even in better studied electrocatalytic reactions, such as the oxygen reduction reaction, the role of each nitrogen type in the catalytic activity is still a matter of heated debate. Since carbon materials are only now emerging as electrocatalysts for the HzOR, the comparative activity of pyridinic, graphitic, and other nitrogens is currently under investigation.

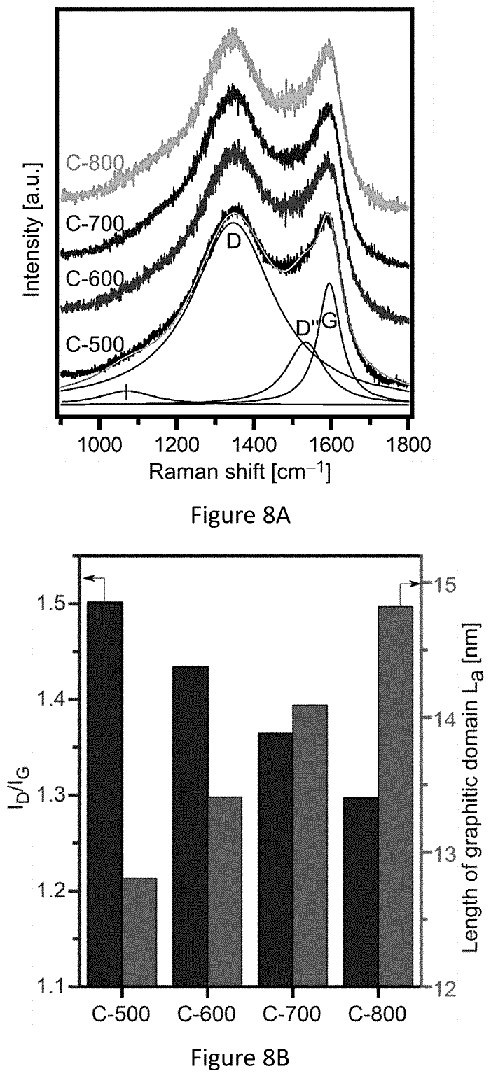

The last important microstructural parameter of a carbon electrocatalysts, is its electronic conductivity. In addition to the turnover number and mass-transfer requirements of the catalyst, the catalytic sites must be electrically wired to the external circuit, in order to shuttle charge to and from these sites. The conductivity of a carbon material is correlated to its degree of graphitization, namely the size, concentration and connectivity of graphitic domains. This, in turn, is described by Raman spectra, which reveal vibrational modes in the carbon structure. The most typical vibrations are the D band at 1350 cm⁻¹, related to inter-plane defects and G band at 1600 cm⁻¹, related to the tangential stretching vibration mode⁵⁸. The degree of graphitization was correlated to the intensity ratio between the D and G Raman peaks (I_{D}/I_{G}). Moreover, this ratio allows one to estimate the characteristic length of graphitic domains in the a direction (Lₐ). The inventors measured the Raman spectra of carbons C-500 to C-800 (FIGS. 8A-B), and deconvoluted them into four bands: G, D, D″ (graphene layers slipping out of alignment) and I(impurity-induced disorder). The I_{D}/I_{G} value decreased gradually along the series from 1.5 to 1.3, which translates to an increase in Lₐ from 12.7 to 14.7 nm. Such a steady and mild graphitization suggests a classic thermal (non-catalytic) graphitization mechanism.

Tailoring the microstructure of a carbon electrocatalyst is a challenging task, as seen in the complex temperature dependencies. With rising temperature, the BaNTA-derived carbons change along wide-ranging trends (Table 1

Table): surface area rises and falls, with a peak at 700° C. (FIG. 6A); so do the mesopore volumes (FIG. 6B).

TABLE 1
Microstructure and composition properties of the C-T samples. Bulk and surface
concentrations of N were obtained by elemental analysis and XPS, respectively.

| | SSA | V_{micropore} | Vₘₑₛₒₚₒᵣₑ | Vₜₒₜₐₗ | Bulk N | Surface N | | | | | | |
|---|---|---|---|---|---|---|---|---|---|---|---|---|
| | (m² g⁻¹) | (cm³ g⁻¹) | (cm³ g⁻¹) | (cm³ g⁻¹) | (at %) | (at %) | Nₚ | Nₒₓ | N_{g} | N_{py} | I_{D}/I_{G} | Lₐ |
| C-500 | 67 | 0.08 | 0.16 | 0.18 | 3.6 | 2.7 | 0.16 | 0.11 | 0.58 | 0.14 | 1.50 | 12.8 |
| C-600 | 584 | 1.70 | 2.54 | 2.70 | 3.8 | 2.4 | 0.27 | 0.06 | 0.57 | 0.09 | 1.43 | 13.4 |
| C-700 | 1031 | 2.98 | 4.31 | 4.56 | 1.3 | 2.7 | 0.22 | 0.10 | 0.53 | 0.15 | 1.36 | 14.1 |
| C-800 | 966 | 1.73 | 2.49 | 2.80 | 0.7 | 1.6 | 0.15 | 0.16 | 0.50 | 0.19 | 1.30 | 14.8 |

Small mesopores shrink gradually (FIG. 4B); graphitization increases monotonously (FIGS. 8A-B), while the nitrogen content remains constant until 700° C., dropping sharply afterwards (FIGS. 7A-C). Each of these aspects of the microstructure was linked to electrocatalytic activity, whether through activity of each catalytic site, or through the ability of the matrix to conduct ions and electrons. Thus, only experiment can determine which pyrolysis temperature leads to the best electrocatalytic activity for HzOR.

### Hydrazine Oxidation Electrocatalysis

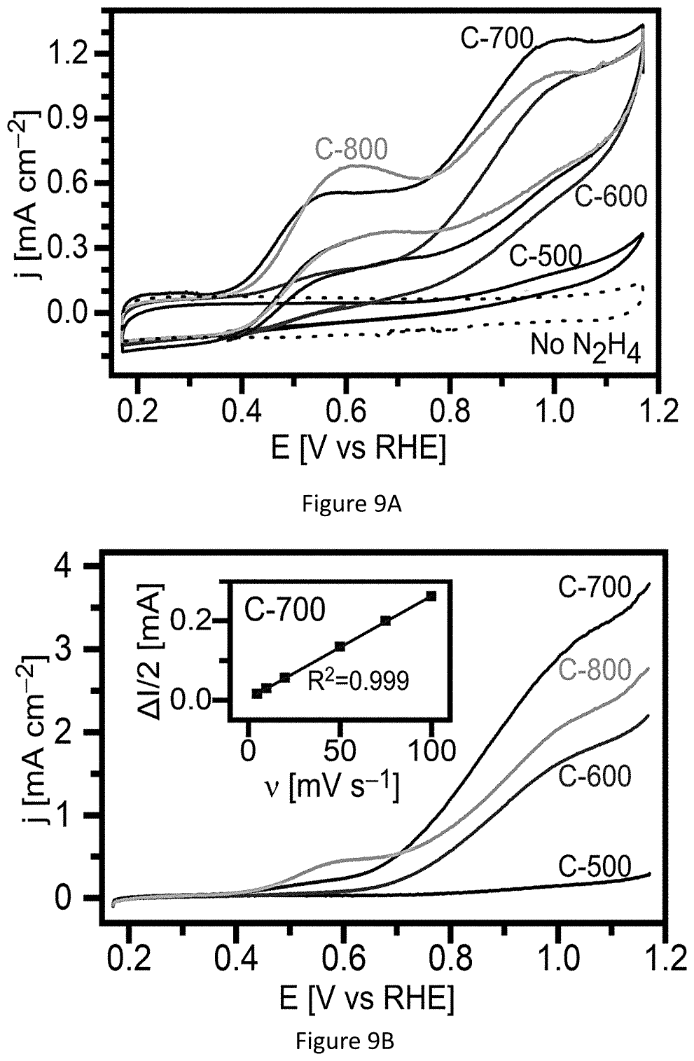

Carbons C-500 to C-800 were all active towards hydrazine oxidation electrocatalysis (FIGS. 9A-B). The earliest onset potentials for oxidation was observed on C-700 and C-800: 0.34 V vs. RHE at pH 14. This potential represents a lower overpotential for the HzOR, as compared to previous metal-free carbons at the same pH range, reported to be 0.4-0.6 V vs. RHE at pH 14. The HzOR efficiency of doped carbon catalysts derived from alkaline earth metal-based precursors was linked with their superior microstructure. In contrast, carbons pyrolyzed at lower temperatures performed worse, with lower onset potentials (as positive as 0.79 V vs. RHE for C-500) and lower current densities.

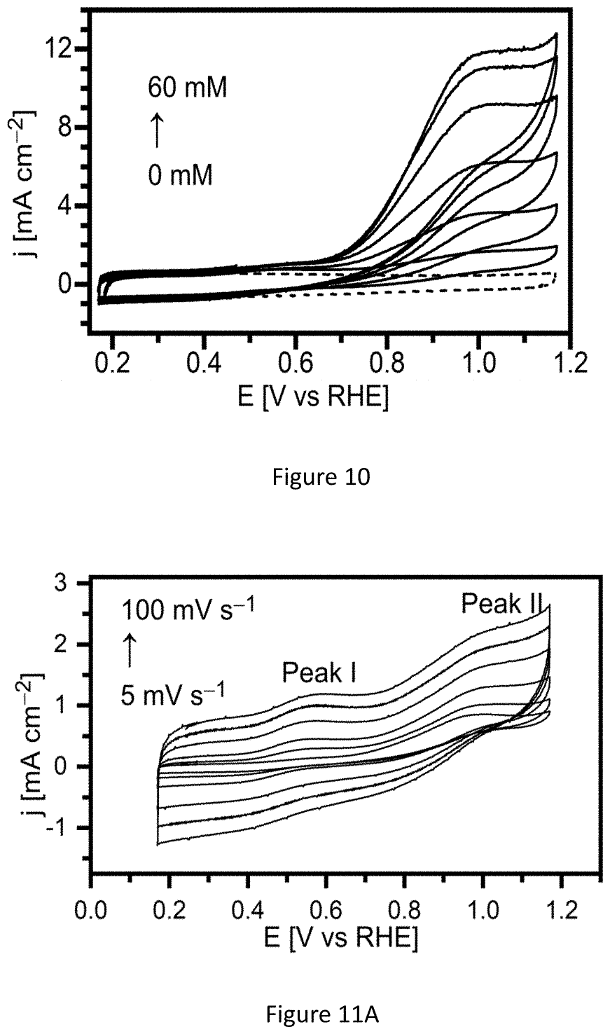

Bubbles formed on all electrodes at high applied potentials and grew with each cycle. To test whether they correspond to N₂ (from complete, 4e oxidation of hydrazine) or to O₂ from the oxidation of water (4OH⁻→2O₂+2H₂O+4e⁻), the inventors varied the concentration of hydrazine during the CV (FIG. 10). The oxidation current density increased steadily with rising concentration of hydrazine, confirming it was indeed the active substrate. In the absence of hydrazine, no current or bubbles were observed (FIG. 10, dashed line). In any case, such early onset potentials would be extremely improbable for the oxygen evolution reaction, whose thermodynamical potential is E⁰=0.496 V vs. RHE at pH 14, and which proceeds through high overpotentials on even the best catalysts. Thus, the bubbles were likely nitrogen, suggesting complete 4e⁻ oxidation of hydrazine. The currents reach a plateau at higher potentials, as commonly observed for the catalytic, mass-transport-limited hydrazine oxidation reaction.

The electrochemical surface area (ECSA) of C-700, the best performing electrocatalyst, was calculated from double layer capacitance charging. Based on 10 separate measurements, the ECSA was found to be 208±43 m² g⁻¹ (FIG. 9B inset). In contrast, the SSA derived from N₂ physisorption was much higher: 1030-1070 m² g⁻¹, based on two separate measurements (FIG. 6A inset). This significant difference suggests that the micropores are not fully exposed to the electrolyte.

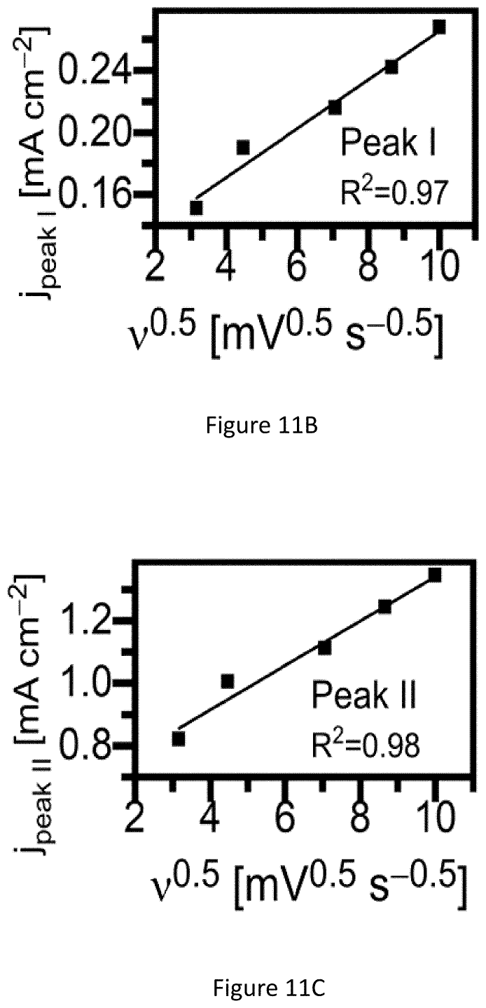

The cyclic voltammetry for C-600 to C-800 exhibits two oxidation waves. Peak I (0.5-0.6 V vs. RHE) is highest on C-800 both in a non-stirred solution, and during electrode rotation at 1600 rpm. Peak II (˜1 V vs. RHE), on the other hand, is higher on C-700 at both conditions. By varying the scan rate during CV, the inventors could study the dependence of current density on diffusion. The inventors varied the scan rate between 5 and 100 mV s⁻¹ and plotted the peak current density (jₚₑₐₖ, corrected for baseline current) versus square root of the scan rate (FIGS. 11B-C). The linearity of the plots for both peak I and II reveals that the reaction rate is diffusion-controlled in both oxidation events. This corroborates the observation that hydrazine is indeed the substrate being oxidized, rather than surface functional groups of the carbon. The double peak CV could be explained by several hypotheses, some of which are discussed here. First, a competing reaction of water oxidation can be ruled out, since no oxidation current is observed in the absence of hydrazine (FIG. 10). Second, a double peak HzOR CV was recently analyzed and explained by local acidification which slows down HzOR near the electrode. However, this only occurs in unbuffered solutions, whereas the inventors operate at such a high concentration of hydroxide ions (1 M KOH) that electrode acidification becomes insignificant. Considering that a typical CV passes ˜2 mC of charge, and assuming faradaic reactions, the acidification is expected to lower the pH by ˜0.001 units only. Thus, the two peaks probably arise from (1) two distinct active sites, and/or (2) stepwise/partial oxidation of hydrazine at different potentials.

Overall, C-700 and C-800 displayed the best electrocatalytic activity towards the HzOR at pH 14, while varying slightly in the current densities they can drive for the first and second oxidation waves. These high oxidation currents correlate well with the superior structure and composition of these materials. Both contain the highest specific surface areas and mesopore volumes. Interestingly, C-700 is richer in nitrogen than C-800: nitrogen was 30% more concentrated at the surface, and over 300% richer in the bulk (FIGS. 7B-C). This reveals that less than 1 at % of nitrogen is sufficient for excellent HzOR activity (as in C-800). On the other hand, C-800 is more graphitic, suggesting it conducts electricity better to/from the active sites. Overall, the difference in activity between the two oxidation peaks on the two catalysts reflects a complex balance between multiple parameters, such as the concentration and type of surface nitrogen functionalities, and the efficiency of their wiring to the external circuit. The fact that the best HzOR catalysts are those pyrolyzed at the end of the TGA mass-loss plateau (FIG. 2), suggests a rational design approach to catalytic carbons; the high temperatures preceding carbon decomposition yield the best surface area, hierarchical porosity and graphitization, while still minimizing nitrogen loss.

### Example 2

### Self-Templating of Hierarchically Porous Carbon Electrocatalysts Using Group 2 Coordination Polymers

### Materials and Methods

### Synthesis of Metal Coordination Polymers (MOCPs)

The inventors delve deeper into the self-templating mechanism, and expand the synthesis to Ca²⁺, Sr²⁺ and Ba²⁺-based coordination polymers. Briefly, metal carbonate, metal hydroxide and nitrilotriacetic acid were mixed in water at a 4:1:5 molar ratio (based on metal ions and NTA units). A clear solution was obtained and stirred for 10 min at 85° C., then left to cool to room temperature. To complete the precipitation, ethanol was gradually added and the solution was ice-cooled. The resulting white precipitate was vacuum filtered, washed with cold ethanol, and vacuum dried at 50° C. for 2 days. The synthesis has been repeated >3 times for each precursor, with identical results.

### Synthesis of Carbons

The MOCP powders were pyrolyzed at 750° C. in Ar atmosphere for 1 h (heating rate 10° C. min⁻¹). These inorganic/carbon composites are denoted as MX@NC, where M=Mg, Ca, Sr, Ba, and X is the anion(s). The inorganic phase was dissolved in hydrochloric acid (1 M, 72 hours), and the resulting carbon (denoted NC-M) was vacuum dried, and annealed again in Ar (1000° C./1 h, heating rate 5° C. min⁻¹).

### Material Characterizations

Powder X-ray diffraction (XRD) was recorded on a Rigaku SmartLab instrument operating at 45 kV and 150 mA, at a wavelength of 1.54 Å. ICDD cards used for powder XRD assignment: MgO (00-004-0829), CaCO₃ (01-075-6049), Ca(OH)₂ (00-044-1481), CaO (01-070-5490), SrCO₃ (00-052-1526), Sr(OH)₂ (00-018-1273), Sr(OH)₂.H₂O (00-028-1222), and BaCO₃ (01-074-2663). Ritveld fitting of different phases showed sufficiently low fitting figures-of-merit (wR<10, GOF˜1). High-resolution scanning electron microscope was done on a Zeiss-ultra+ at 4 kV and in-lens detector, on the NC-M samples prior to the final annealing (samples after the final annealing showed identical morphologies). Energy dispersive spectroscopy (EDS) was measured with a Quantax spectrometer (Bruker) at 7 kV. High-resolution transmission electron microscopy (HRTEM) was performed on FEI Talos 200C, at an acceleration voltage of 200 kV. N₂ adsorption-desorption isotherms were measured on a Micromeritics 3Flex instrument at 77 K, using vacuum-dried samples. The isotherms were analyzed using the two-parameter Brunauer-Emmett-Teller (BET) model for specific surface area (SSA, at P/P⁰ values of 0.01-0.15) and by non-local density functional theory (NLDFT) isotherm fitting for pore size distribution (using the adsorption branch of the isotherm). Raman spectroscopy was performed on a Horiba LabRam HR Evolution Raman microscope using ×10 lens, 532 nm laser excitation wavelength, and 1800 grating. First-order Raman spectra were fitted iteratively with four Lorentzian components. X-Ray photoelectron spectroscopy (XPS) was collected on a PHI VersaProbe III scanning microprobe supplied from Physical Instruments at UHV˜10⁻¹⁰ torr, step size 0.05 eV. Peaks were calibrated using the C1s position (284.5 eV), and deconvluted in CasaXPS.

### Electrochemical Measurements

The oxygen reduction reaction voltammograms were recorded on a BioLogic VSP bipotentiostat, combined with a Pine rotating electrode setup. Carbon powder inks were prepared by sonicating 1 mg of carbon, 300 μL of deionized water, 180 μL ethanol and 20 μL of Nafion 5 wt % dispersion (Alfa Aesar). 10 μL of the ink were dropcast onto a rotating ring-disk electrode (RRDE; glassy carbon disc ϕ=5.61 mm, Pt ring, loading 81 μg cm⁻²), and dried at 50° C. Experiments were conducted in 0.1 M KOH at 25.0° C., saturated by O₂ (for ORR measurements) or N₂ (for baseline measurements) by bubbling for 30 minutes, and kept under a gas blanket. Currents in N₂-purged solutions were subtracted from those in the O₂-purged solutions, to account for capacitive currents. Graphite and saturated calomel (SCE) were used as counter and reference electrodes, respectively. Potentials were applied using an automatic 85% iR correction. Reported potentials were converted to RHE by adding 0.242 V and 0.0592 V for every pH unit, a total of 1.011 V. Before measurement, the electrode was wetted by 20 cycles between 0.1 V and −0.7 V vs. SCE at 100 mV s⁻¹. The number of electrons transferred per 02 molecule (n) was calculated by the Koutecký-Levich method from linear sweep voltammograms performed on a rotating disk at rotation speeds of 200-2400 rpm, as described elsewhere.²² The yield of H₂O₂ (%) was calculated by Eq. 1, where i_{ring} is the ring current, and i_{disc} is the disc current. The collection efficiency was determined experimentally to be N=0.35, using 4 mM of the Ru(III)/Ru(II) hexamine couple in N₂-purged 0.1 M KCl.

$$\% {H}_{2} {O}_{2} = \frac{2 \cdot {i}_{ring} / N}{{I}_{disk} + {i}_{ring} / N} \cdot 100 \qquad Eq . 1$$

### Results and Discussion

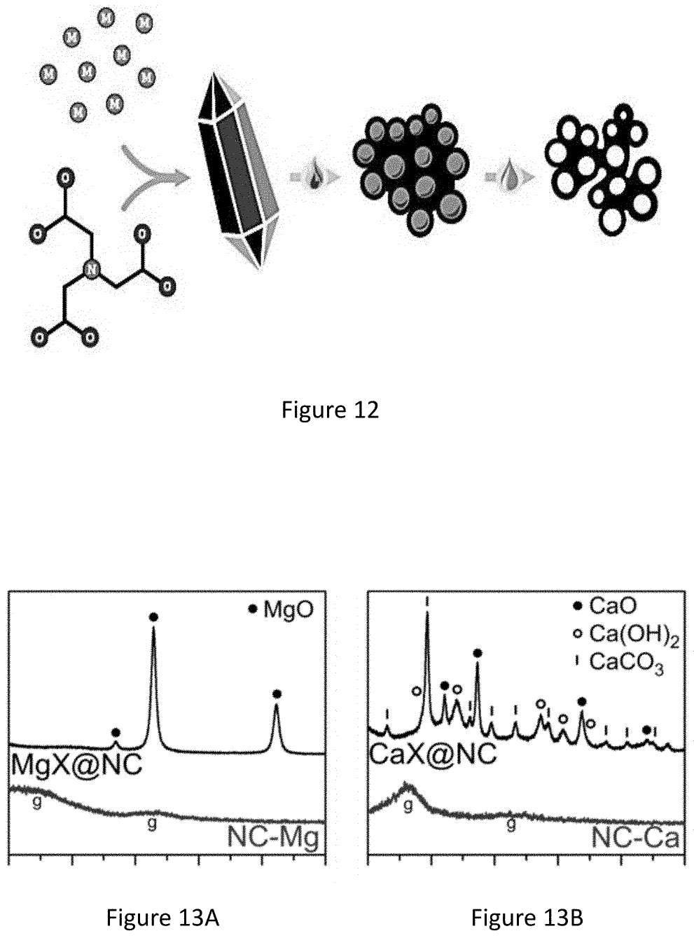

The self-templating, or endo-templating synthetic strategy combines advantages from both approaches (FIG. 12), being a type of hard templating, yet avoiding the addition of any external template. Simple yet specifically designed metal-organic coordination polymers (MOCPs) serve as both a source and a spontaneous template for the final carbon material. During pyrolysis, the organic ligands are carbonized to yield a carbon matrix, doped by atomic or nanoparticulate metal sites. In parallel, inorganic particles form inside the carbon; they can then be washed away, serving as in situ templates for meso- and macropores (depending on degree of agglomeration). Furthermore, the presence of the metal ions during pyrolysis contributes to micropore etching and to carbon exfoliation, boosting surface area and exposure of catalytic sites. Thus, careful design of the metal-organic precursors can expand the scope of controlled nanostructures, and enable fundamental studies of synthesis-structure and structure-activity correlations in these promising electrocatalysts materials.

The inventors report a systematic study of the self-templating synthesis of carbon materials, using Group 2 MOCP precursors. Alkaline earth metal ions are highly abundant: Mg²⁺, Ca²⁺, Sr²⁺ and Ba²⁺ are the 7^{th}, 5^{th}, 14^{th} and 16^{th} most abundant elements in the earth's crust, respectively. Importantly for electrocatalysis research, Group 2 metal ions are electrocatalytically inactive, allowing them to direct structure formation without masking the catalytic activity. Nevertheless, these promising elements are under-represented in the field of MOCP-derived carbons, dominated by precursors based on Fe^{2+/3+}, C²⁺, Zn²⁺, and Al³⁺ salts.

To understand in detail how the carbon microstructure evolves during the self-templating synthesis, to explore the expected richness of Group 2-derived precursors, and to try and correlate structure to electrocatalytic activity, the inventors took a systematic approach. The inventors prepared a homologous series of MOCPs based on Mg²⁺, Ca²⁺, Sr²⁺ and Ba²⁺ with a single common ligand, nitrilotriacetic acid (H₃NTA). The ligand is both cheap and flexible, providing high binding versatility to different ion sizes. By combining a broad range of material characterization techniques with oxygen reduction reaction (ORR) electrocatalytic studies, the inventors investigated the effect of the metal ion on the material morphology throughout the self-templating pathway. The carbons produced by this method spanned the full porosity range between pure microporosity to rich hierarchical porosity. The pore size distribution was found to determine both ORR activity (through boosting flow) and selectivity (through confinement of intermediates).

### MX@NC Composites: Template Formation

The Group 2 nitrilotriacetates are crystalline powders, as determined by XRD and electron microscopy. Their single crystal X-ray diffractograms show well-defined crystals of metal-organic coordination polymers, sharing a common M(NTA)₃(H2O)ₓ composition: MgNH(CH₂COO)₃(H₂O)₃, CaNH(CH₂COO)₃(H₂O)₂, SrNH(CH₂COO)₃(H₂O)_{1.5}, and BaNH(CH₂COO)₃.

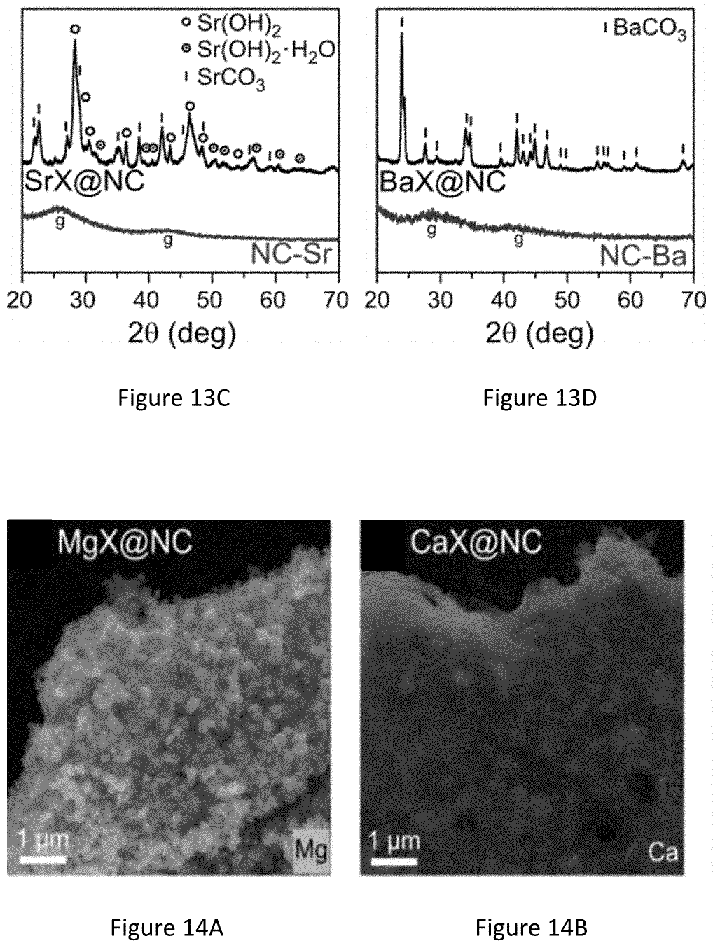

Thermal treatment of the four MOCPs in argon atmosphere (750° C./1 hr, heat rate 10° C. min-1) converted them into black powders. While MgX@NC and BaX@NC are light and fluffy, SrX@NC is somewhat denser, and CaX@NC is a dense and hard powder. The crystalline phases in each composite were identified by XRD (FIGS. 13A-D) and quantified by Ritveld analysis. The smallest (Mg²⁺) and largest (Ba²⁺) cations yielded only a single phase of crystalline nanoparticles (MgO and BaCO₃) during the thermal treatment. In contrast, Ca²⁺ and Sr²⁺ produced a mixture of inorganic phases: CaX@NC contains CaO, Ca(OH)₂ and CaCO₃ at roughly 20-30-50% proportions, and SrX@NC contains Sr(OH)₂ and SrCO₃ (two similar phases of each) at a 50-50% ratio. Qualitatively, the oxide-hydroxide-carbonate sequence of binary phases (from MgO to BaCO₃) can be explained by Pearson's hard-soft acid-base theory. The least polarizable, Lewis-acidic Mg²⁺ cations (r=86 pm) form the most stable interactions with similarly hard base O²⁻ anions, while large and polarizable Ba²⁺ cations (r=149 pm) are most stable with similarly soft base CO₃²⁻ anions.

To explain the phase composition along the oxide-hydroxide-carbonate sequence, the inventors consider the possible inorganic reactions during pyrolysis (Eq. 2-5). At the pyrolysis temperature of 750° C., the oxides are expected to be more stable than the hydroxides, and less stable than the carbonates. However, the composition is unlikely to be under thermodynamic control. First, the reducing, carbon-rich matrix may shift the equilibria towards hydroxides and carbonates. Second, atom diffusion is slow: only two of the phases are liquid at this temperature (Ca(OH)₂ mp 580° C., Sr(OH)₂ mp 375° C.), while all others are solids far from their melting points (ranging 1340-2570° C.). This will slow down diffusion in these materials, making dynamic equilibration of the MO [symbol] M(OH)₂ [symbol] MCO₃ mixtures unlikely after only one hour at the pyrolysis temperature. Finally, the presence of Ca(OH)₂ and Sr(OH)₂ may also result from rapid re-hydration of the oxides,40,41 at any time during or after pyrolysis. Such hydroxide phases are often extended (rather than particulate), possibly leading to loss of pore-templating abilities. Overall, precise tuning of the pyrolysis temperatures and times could prove a highly efficient method for tweaking the composition of the templating phases.

| | |
|---|---|
| Eq. 2 Ca(OH)₂ [symbol] CaO + H₂O | Tdecomp = 520-580° C. |
| Eq. 3 CaCO₃ [symbol] CaO + CO₂ | Tdecomp = 750-800° C. |
| Eq. 4 Sr(OH)₂ [symbol] SrO + H₂O | Tdecomp = 600-700° C. |
| Eq. 5 SrCO₃ [symbol] SrO + CO₂ | Tdecomp = 900-1000° C. |

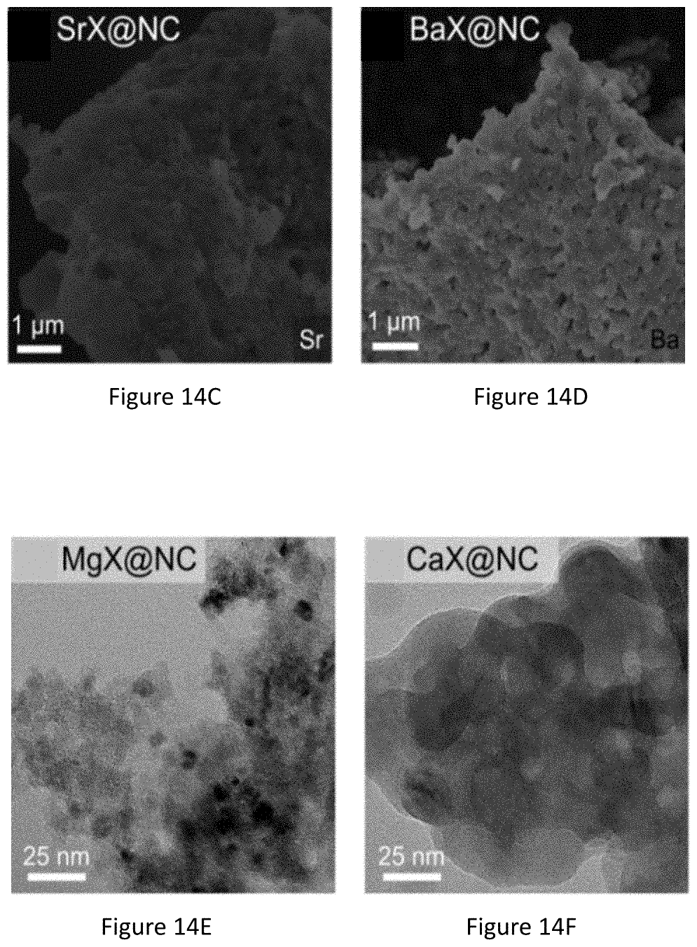

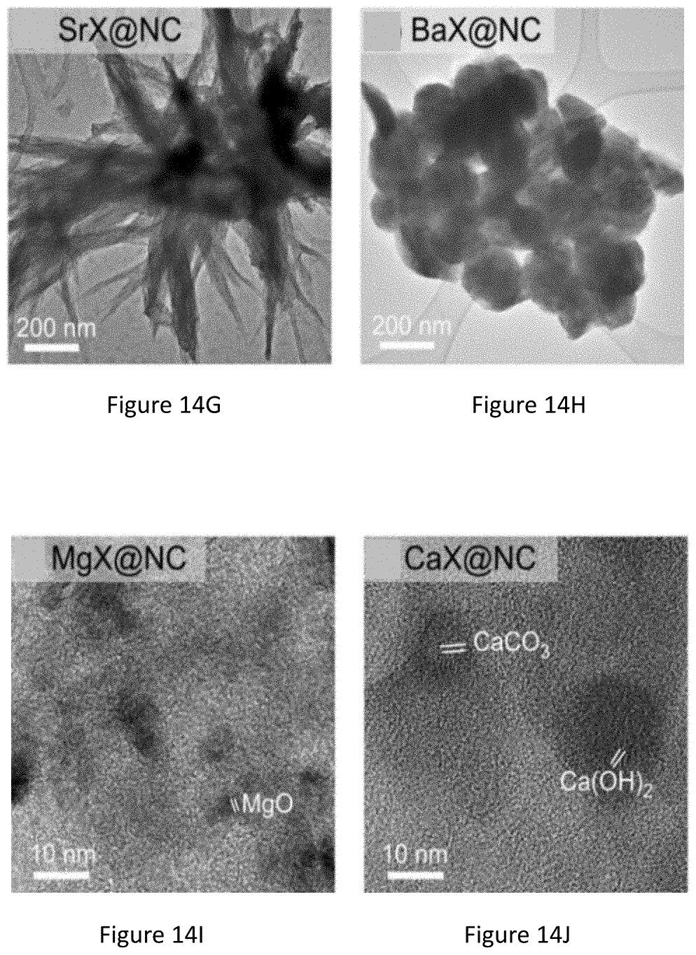

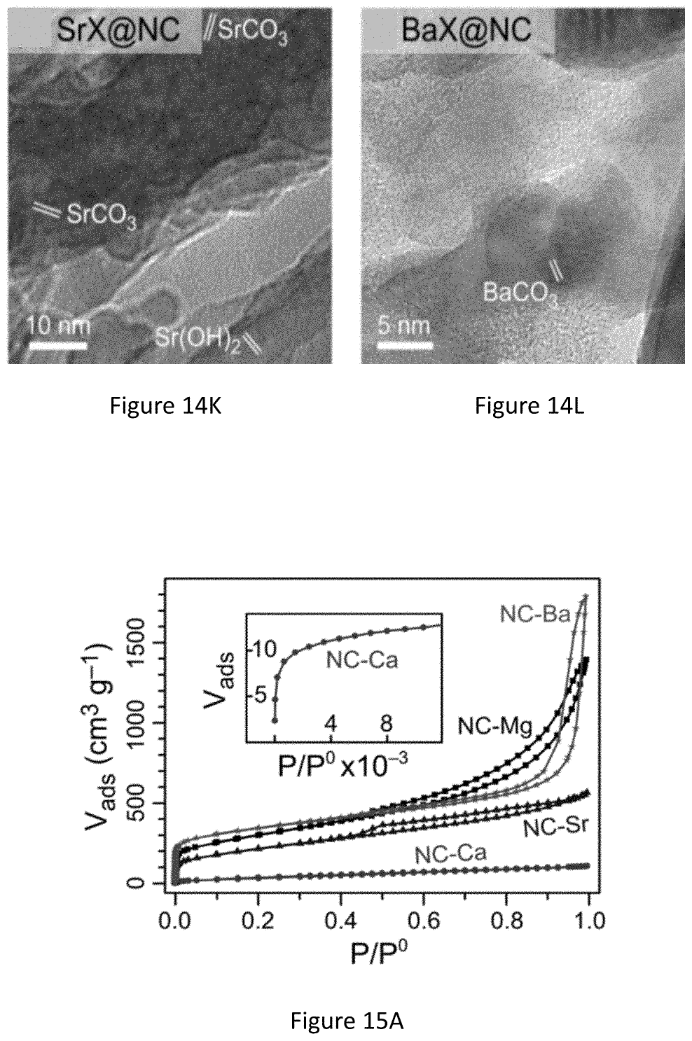

The sizes, shapes, and agglomeration of the inorganic particles were studied by HRSEM with elemental mapping by EDS (FIGS. 14A-D) and by HRTEM at two magnifications (FIGS. 14E-L). The MgO particles in MgX@NC (FIG. 14E and FIG. 14) are identified by their crystal spacings in corroboration of the XRD data. The MgO particles are the smallest: 6±1 nm diameter, close to the 9±1 nm obtained from XRD broadening (Table 2). Nevertheless, the match between their dimensions and the size of the coherently scattering crystallites suggests they have few defects. The MgO nanoparticles are well dispersed through the material (EDS in FIG. 14A), and agglomerates are small and disordered.

TABLE 2
Composition and structure of the inorganic
MX phases in the MX@NC composites

| | | Phase | Crystallite | Particle size |
|---|---|---|---|---|
| Metal | Inorganic | fraction | size (XRD) | (TEM/SEM) |
| ion | phase | (%)^{a)} | [nm]^{b)} | [nm]^{c)} |
| Mg²⁺ | MgO | 100 | 9 ± 1 | 6 ± 1 |
| | | | | aggl. 10 s-100 s |
| Ca²⁺ | CaO | 21 | 15 ± 2 | aggl. 100 s |
| | Ca(OH)₂ | 31 | 8 ± 1 | |
| | CaCO₃ | 48 | 14 ± 3 | |
| Sr²⁺ | Sr(OH)₂ | 55 | — | 100 s |
| | SrCO₃ | 45 | — | |
| Ba²⁺ | BaCO₃ | 100 | 26 ± 4 | 30 ± 10 |
| | | | | aggl. 200 ± 30 |

^{a)}Obtained by Ritveld analysis of the XRD.
^{b)}Determined by Scherrer analysis of the XRD broadening, average between several peaks. This analysis could not be performed for the Sr²⁺-based phases,
^{c)}Obtained by image analysis of many particles in the HRSEM or HRTEM images, aggl. denotes sizes of agglomerates.

Well-dispersed particles were also found at the other extreme of the alkaline-earth series, in the case of BaCO₃@NC (FIG. 14D). The spherical nanoparticles have diameters of 30±10 nm (HRTEM), similarly to the size of coherently scattering domains (26±4 nm), suggesting low defect density. In contrast to the small and disordered agglomerates of MgO, the primary BaCO₃ nanoparticles aggregate into highly uniform, well-packed, spherical agglomerates, diameter=200±30 nm (FIG. 14H and FIG. 14L). The known tendency of BaCO₃ to agglomerate, will therefore govern their pore-templating activity.

In CaX@NC, the Ca-based particles are larger (10s-100s of nm, FIG. 14B, FIG. 14F, FIG. 14J), yet shapes and precise dimensions of individual particles are hard to determine. XRD broadening reveals that the coherently scattering domains are much smaller, on average (8-15 nm for the three phases), indicating multiple defects and/or significant agglomeration. Similarly, the SrCO₃ phase in SrX@NC is extended, adopting the acicular (elongated and branched) crystal habit, typical for the strontianite SrCO₃ mineral. Branches are 50-90 nm thick and 300-700 nm long (FIG. 14C, FIG. 14G, FIG. 14K). Individual SrCO₃ and Sr(OH)₂ particles are hard to discern, but are identified by their crystal plane spacings (FIG. 14K). This suggests that Ca-based and Sr-based particles are all agglomerated, yet well-dispersed throughout the material (FIG. 14B, FIG. 14C).

Overall, the homologous series of alkaline-earth MOCPs yields various carbon-embedded inorganic phases, ranging in size, shape, crystallinity, and degree of agglomeration. These are expected to template a broad variety of pore size distributions.

### NC-M Carbons: Self-Templating of Porosity

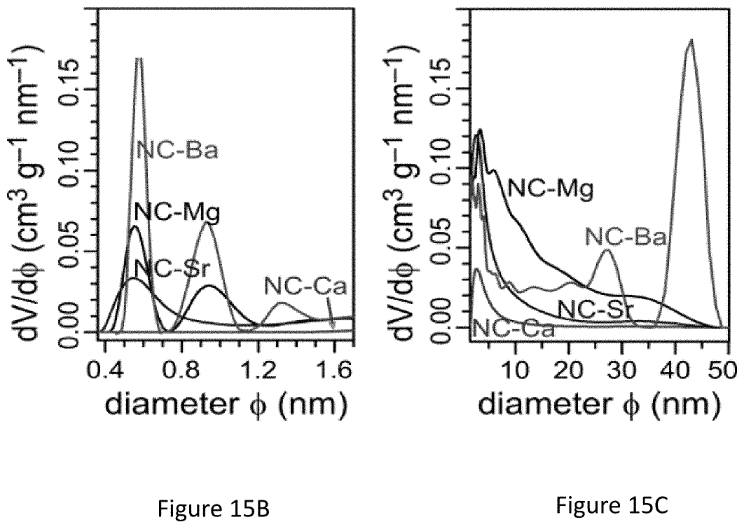

To understand the evolution of hierarchical porosity in this series of self-templated materials, the inventors examined both the quantitative (N₂-sorption derived) and qualitative (electron microscopy-derived) pore size distributions. Adsorption-desorption isotherms of N₂ at 77K were collected for all four NC-M carbons (FIG. 15A), and used to calculate the specific surface areas (SSAs) by the BET model (Table 3). The pore size distributions were calculated using NLDFT model for both the micropore and mesopore ranges (FIGS. 15B-C).

TABLE 3
Surface areas and pore volumes of NC—M carbons^{a)}

| | SSA | Vₜₒₜₐₗ | V_{micropore}^{b}) | V_{meso+macro}^{c)} |
|---|---|---|---|---|
| Carbon | [m² g⁻¹] | [cm³ g⁻¹] | [cm³ g⁻¹] | [cm³ g⁻¹] |
| NC—Mg | 1040 | 2.2 | 0.43 | 1.73 |
| NC—Ca | 140 | 0.17 | 0.04 | 0.13 |
| NC—Sr | 740 | 0.87 | 0.30 | 0.57 |
| NC—Ba | 1220 | 2.8 | 0.50 | 2.30 |

^{a)}Determined by N₂ adsorption at 77 K, fitted by BET model.
^{b)}Volume of N₂ adsorbed at P/P⁰ = 0.99.
^{c)}Vₜₒₜₐₗ − V_{micropore}.

The simplest morphology is found in NC-Ca, featuring a type I isotherm, typical for strictly microporous materials. Indeed, the pore size distribution reveals no significant mesoporosity, especially in comparison with the other carbons. Thus, no self-templating occurred in NC-Ca, despite the presence of Ca-based inorganic phases in the material. Micropores in the bulk, typically formed homogeneously in pyrolyzed polymers, were inaccessible; rather, only the surface micropores of NC-Ca are accessible to N₂.

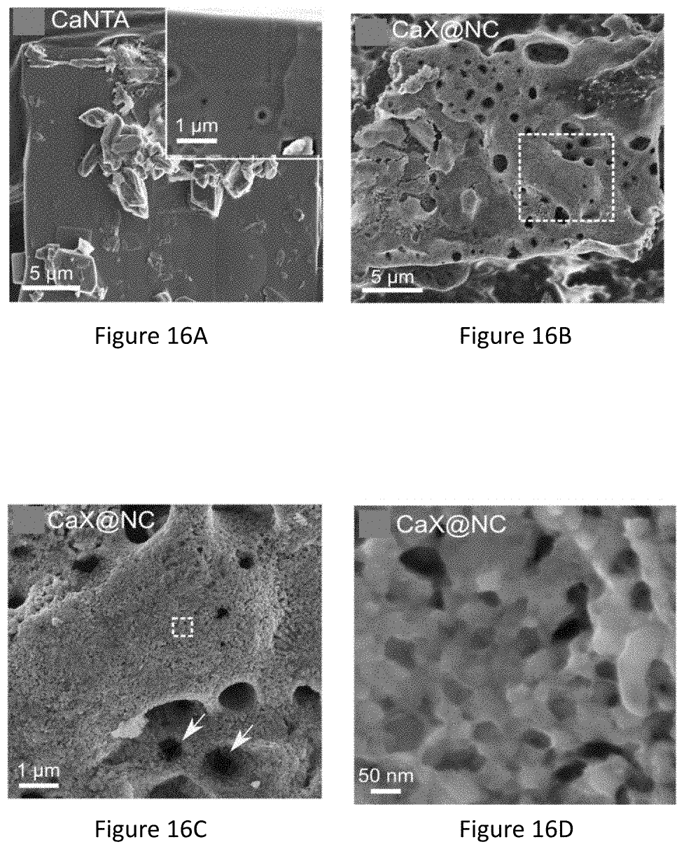

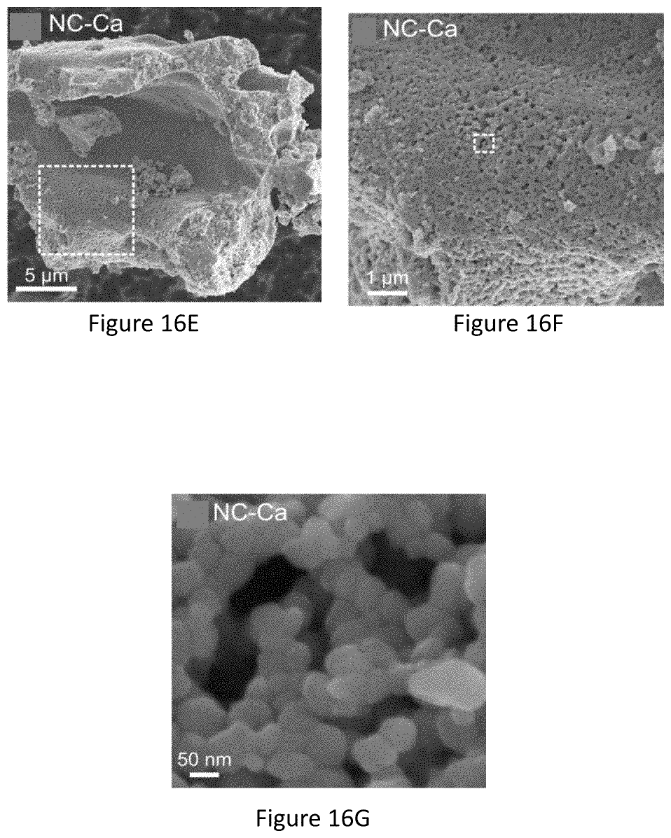

Crystallites of CaNTA, the carbon precursor, are tabular and smooth, ranging tens of micrometers in size (FIG. 16A). The shapes and dimensions of the macroscopic crystals were retained during the thermal treatment, as the organic ligand was carbonized and the Ca-based inorganic phases were formed (FIG. 16B). The resulting CaX@NC composite was quite dense at all magnifications (FIGS. 16B-D), with a few 0.5-2 μm holes dispersed on the surface.

After washing the material in acid, the NC-Ca particles retained the original macroscopic dimensions of the CaNTA crystals (FIG. 16E), but were composed of a dense array of carbon nanoparticles (40-60 nm, FIGS. 16F-G). All Ca-based inorganic phases were completely removed by the acid wash (FIG. 13B, bottom trace), including the translucent films (FIG. 16D vs. FIG. 16G). However, the carbon matrix was nearly as dense as before the wash, with only a minor contribution of new porosity in the 50-200 nm range (FIG. 16F-G). These pores match in size the Ca-based agglomerates observed in FIG. 14B and FIG. 14F, suggesting that the meagre mesoporosity found in NC-Ca was self-templated.

Efficient self-templating by Ca salts strongly depends on the pyrolysis conditions (affecting carbonate decomposition) and on the linker. Overall, the microporosity observed in FIGS. 15A-C was only available at the surface, stressing the importance of ligand choice in the self-templating strategy.

The next carbon examined, NC-Sr, shows N₂ sorption isotherms of the H₄ type (FIG. 15A): mostly microporous with a small hysteresis loop, suggesting a tiny fraction of larger pores. Indeed, the pore size distribution (FIG. 15C) trails into the small mesopore range (up to −15 nm). Many more micropores were accessible to N₂ in NC-Sr than in NC-Ca, as seen in the 7-fold increase in Vmicro and 5-fold increase in specific surface areas (Table 3). This may suggest that either (1) the surface texture of the carbon matrix is radically different between the two samples, or (2) the texture is similar, but more of it is exposed in NC-Sr. Since the carbons were derived from the same ligand, the first hypothesis is unlikely; see below for experimental support for this point. Higher surface exposure, however, is possible—but it must arise from added macro—, rather than meso-pores, since the latter are still few in NC-Sr (FIG. 15C).

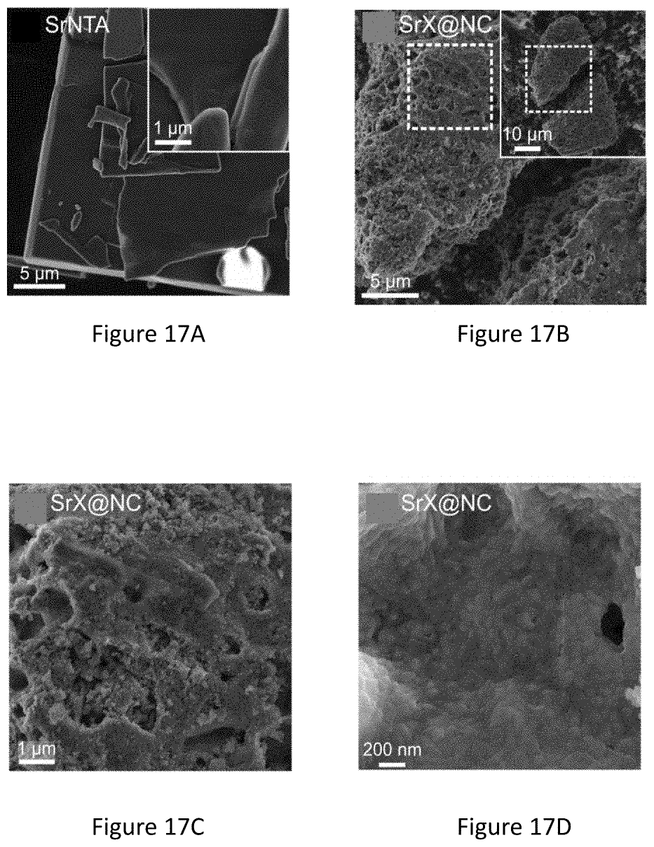

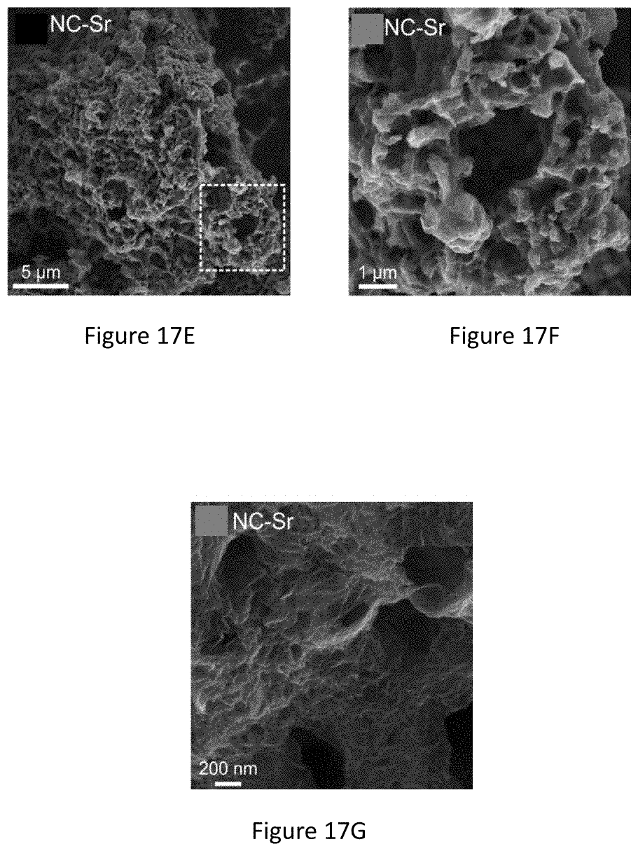

To test this hypothesis, the inventors first examine the SrNTA crystals: platy, smooth, and around ten microns across (FIG. 17A). Their similarity to CaNTA continues with pyrolysis, as the SrX@NC composite is also made of large, dense particles, disrupted by rare micrometer-sized holes (FIGS. 17B-D). However, the acid wash changed the texture dramatically, making it highly open and tortuous on the micrometer scale (FIGS. 17E-F). This boost in macroporosity can indeed expose many of the micropores in the material, corroborating the porosimery data. Interestingly, the surface texture remained dense, and terraced with distinct carbon layers (FIG. 17G). The correlation between macropore-templating and strontianite branches was weak, but may be supported by the only other report of a strontium salt used to template carbon. There, elongated features in the ˜100 nm range are observed in the TEM micrographs, possibly due to macropores. Overall, the large Sr-based inorganic particles in NC-Sr template macroporosity more than in NC-Ca, but the extensive nature of the SrCO₃ and Sr(OH)₂ phases yields large macropores and no mesopores. Thus, they are yet unfit for the self-templating of truly hierarchical porosity that ranges across several orders of magnitude in diameter.

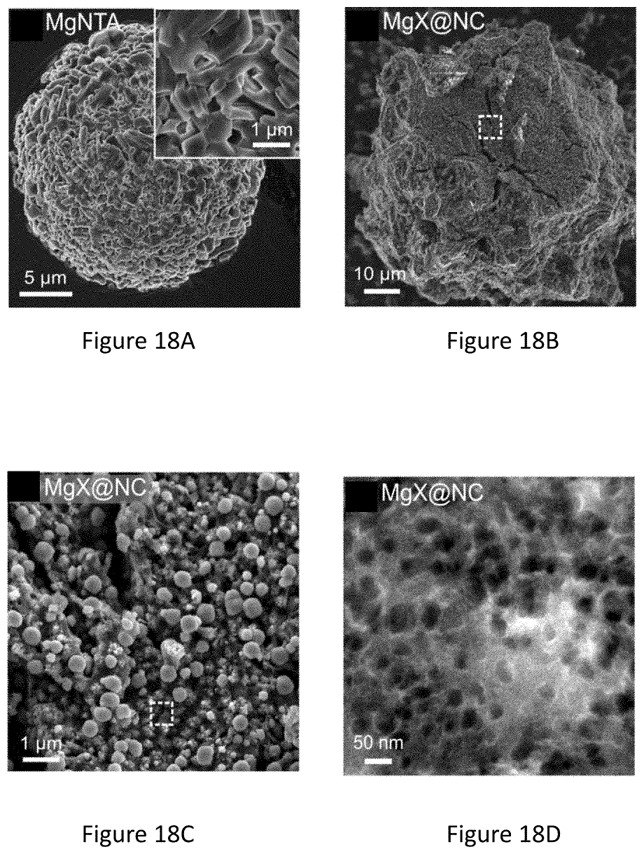

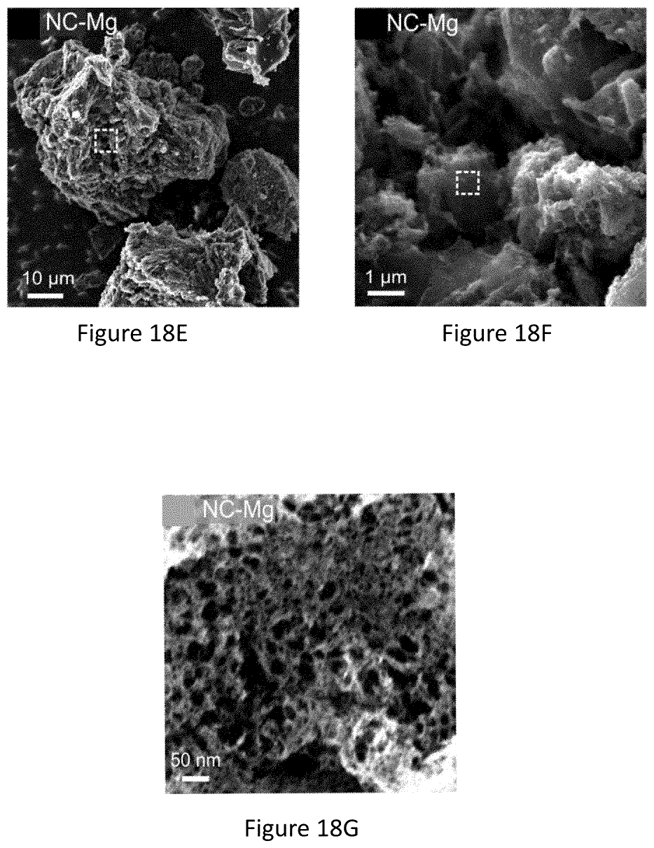

Unlike NC-Ca (microporous) and NC-Sr (micro- and macroporous), the next two carbons have fully hierarchical porosities, spanning the micro-, meso- and macropore range. The MgNTA precursor is already different, composed of large aggregates (10s of micrometers) of prismatic crystallites (˜1 μm long and tens of nanometers wide (FIG. 18A). Upon pyrolysis, these aggregates yield composite MgX@NC, roughly retaining the precursor aggregate dimensions. The particles were cracked and contained many pores in the 10s-100s nm range, typically next to spheres of the same dimensions. The spheres ranged in size from <10 nm (as observed by TEM, FIG. 14E and FIG. 14I) to large spherical agglomerates spanning from 10s to 100s of nm. The subsequent removal of the spheres by acid washing identified them as MgO. The small sizes of the MgNTA crystallites are expected to limit the starting size of MgO spheres, thus strongly affecting mesopore templating.

The spherical meso- and macro-pores were perfectly retained during the acid wash, with diameters up to 40 nm according to N₂ sorption porosimetry (FIG. 15C) and electron microscopy (FIG. 18G). It is likely that the MgO particles form and agglomerate inside the MOCP as it is carbonized; then they are rejected from the carbon matrix, leaving behind a network of meso- and macro-pores. The exsolution, agglomeration, and sphericity of MgO particles all point to a high interfacial energy with the carbon matrix. Indeed, the MgO surface is hydrophilic (contact angle with water of 47°), unlike carbon which is hydrophobic. The hierarchical porosity was quantified by N₂ physisorption (FIGS. 15A-C), with a BET SSA of 1040 m² g⁻¹ and significant micro- and mesoporosity (0.5-50 nm)—as observed directly by HRSEM (FIG. 18G).

The effect of crystallite size in the metal-organic precursor has not been reported previously, and the exsolution of MgO templates was never directly observed. Overall, magnesium-based self-templating is excellent for hierarchical porosity, since the MgO spheres span a broad distribution of sizes, and easily leave behind a stable network of pores.

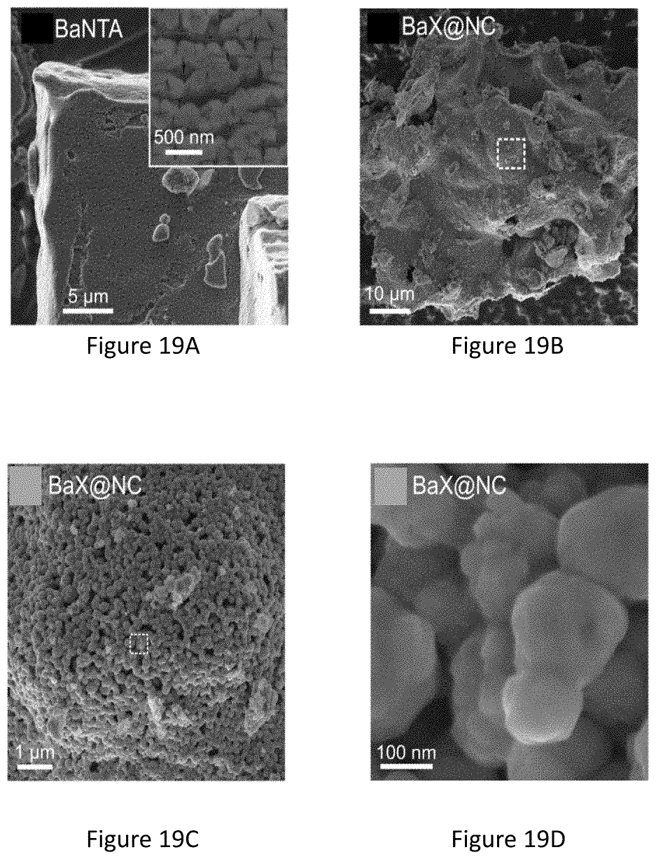

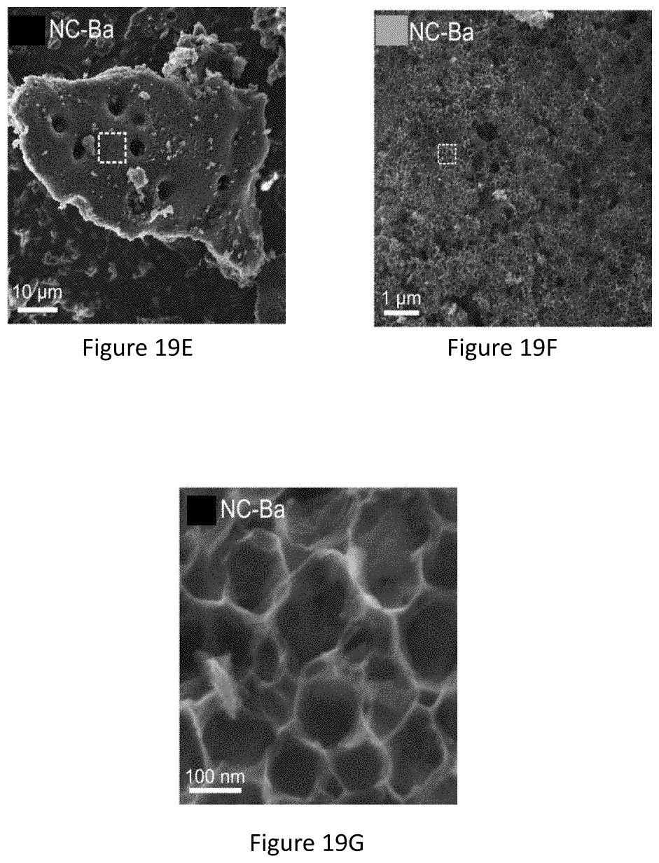

Similarly to MgNTA, the BaNTA MOCP yields a carbon with fully hierarchical porosity. The pathway, however, is quite different. The original BaNTA crystals are tabular and tens of microns large, like those of CaNTA and SrNTA (FIG. 19A). Unlike them, however, BaNTA crystals are not smooth but rather cracked in a regular pattern (periodicity 200-400 nm, FIG. 19A inset). After pyrolysis, the large BaX@NC particles were composed of uniformly sized granules (FIGS. 19B-D). These granules were ˜200 nm in size (FIG. 14H, FIGS. 19C-D, Table 2), similarly to the frequency of cracks in the BaNTA crystal. This suggests that the cracks in the crystal serve as highly useful ‘cutting lines’, along which the crystallites separate during pyrolysis.

After the acid wash, the particle retained its overall shape, yet became highly porous, showing a homogeneous array of similarly sized macropores (˜80-150 nm, FIG. 19G). The sizes of these pores correspond nicely to the size of granules in BaX@NC; the pores are slightly smaller, probably due to shrinking during pyrolysis. This size correlation suggests that the granules are carbon-encapsulated BaCO₃. Their irregular shapes indicate they are polycrystalline agglomerates of primary BaCO₃ crystallites. Indeed, Scherrer analysis determines that the size of coherently scattering BaCO₃ crystals as 26±4 nm (Table 2), much smaller than granule diameters.

The pore size distribution in NC-Ba, calculated from N₂ sorption, revealed a distribution of small mesopores (>2 nm), and two peaks at 25 and 40 nm (FIG. 15C); larger pore diameters cannot be detected by N₂ sorption. The 25 nm mesopores perfectly match the size of individual BaCO₃ nanoparticles (Table 2), indicating some of them are non-agglomerated. Overall, the particle size distribution of the BaCO₃ agglomerates is narrow, similarly to the reported pyrolysis of barium citrate, where it centered on 15 nm. This narrow distribution indicates a fine balance between the interface energies at both the BaCO₃|BaCO₃ and BaCO₃|carbon interfaces. Such a balance provides an opportunity for tailoring the self-templating of porosity in this material. This further suggests that BaCO₃ particles can be used as excellent external additives for hard templating of large mesopores, beyond the self-templating strategy, the way that MgO additives are used for introducing small mesopores into carbons.

Overall, this homologous series of carbons covers the full range of pore modalities. Starting from a microporous carbon with only surface micropores (NC-Ca), to a cracked macroporous carbon exposing some bulk micropores (NC-Sr), and finally to fully hierarchical micro-meso-macro-porosities in NC-Mg and NC-Ba, differing in mesopore size (˜20-40 nm and ˜80-150 nm, respectively). An interesting control experiment would be a non-templated carbon derived from pure, non-complexing NTA. However, nitrilotriacetic acid is volatile and does not carbonize.

This structural richness is expected to be crucial for electrocatalytic activity, as the optimal balance between void network and carbon network is sought. First, the variance in the exposure of bulk micropores will affect the availability of catalytic sites, and the flow rates for the replenishment of reactant (O₂) and the removal of products (OH⁻) and intermediates (HO₂⁻). Second, excessive porosity may lead to undesirably thick catalyst layers, to provide enough catalytic sites within the catalyst volume.

Importantly for the understanding of self-templating mechanisms, the inventors hypothesize that such well-dispersed mesoporosity as in NC-Mg and NC-Ba depends critically on the small size of the crystallites in the MOCP precursors. The sub-micronic dimensions of the MgNTA prismatic crystallites, and of the homogeneous cracks in BaNTA crystals, limit the sizes of inorganic particles as they nucleate during pyrolysis. This opens new avenues in porosity design, suggesting that the fine-tuning of MOCP crystallization conditions can control the self-templating behavior during pyrolysis.

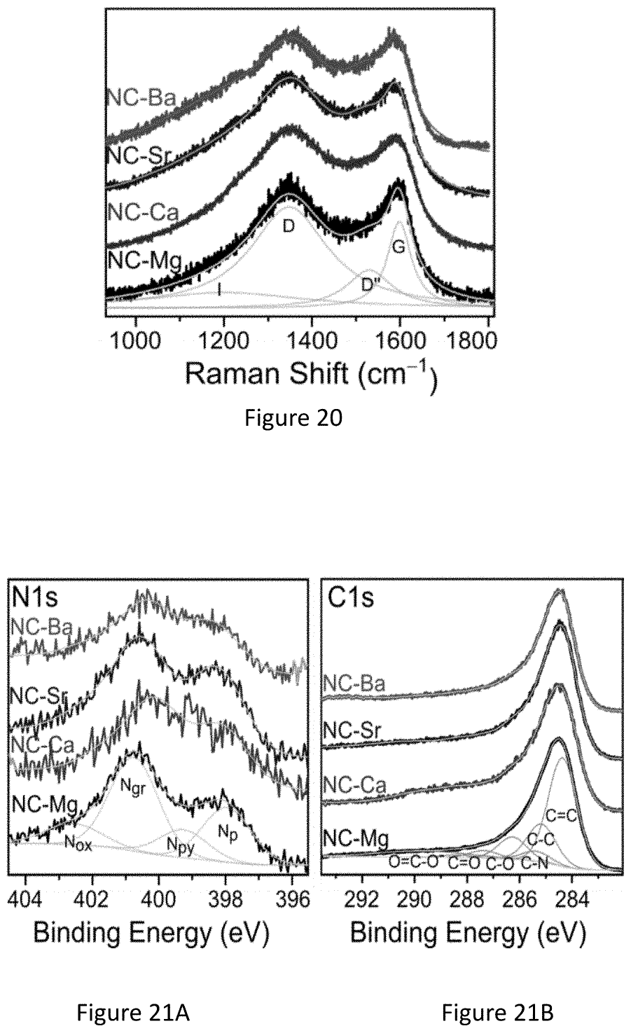

Since the N-doped carbons were all derived from a similar M(NTA)₃ precursor composition, the inventors hypothesized that the carbon composition will be constant along the series. To test this hypothesis, the inventors studied the NC-M carbons by Raman spectroscopy (FIG. 20), inductively coupled plasma mass spectroscopy (ICP-MS), XPS (FIG. 21), and HRTEM. The deconvoluted Raman spectrum for NC-Mg, showed both high frequency E2g in-plane stretching of sp2 carbons, typical to graphitic regions (G), and lower frequency A1g vibrations, activated near carbon defects (D). Other peaks (D″, I) were also fitted according to accepted assignments. The intensity ratio between the D and G bands (ID/IG) expresses the degree of graphitization of the carbon, which, in turn, correlates to its conductivity. While this correlation is imperfect—especially in N-doped carbons where dopants introduced defects—it remains the method of choice in the powder carbon literature, since contact measurements (e.g. 4-point-probe) mostly asses inter-, rather than intra-particle conductivity. The Raman spectra of all four NC-M carbons were indeed very similar, and the ID/IG ratios are within a narrow range (1.13-1.29, FIG. 20). In the context of electrocatalysis, the similar graphitization suggests that the carbons will have similar electronic conductivity.

Transmission electron micrographs of NC-M carbons show similar graphitic regions, ˜3-10 layer thick. For NC-Mg and NC-Ba, these graphitic layers form shells around the inorganic particles. This is the first report of a Ba-based inorganic phase that can catalyze mild graphitization during pyrolysis. Mild graphitization is important for avoiding the uncontrolled growth of carbon nanotubes or large graphite blocks, as many electronic and electrochemical applications seek low dimensional carbon materials.

The NC-M carbons have a high nitrogen content (4.5-7.7 wt %), and very low trace metal content after the acid wash (0.04-0.21 wt %), as determined by ICP-MS (Table 4).

TABLE 4
Composition of the final NC—M carbons.

| | | N wt | M wt | Nₚ | N_{py} | N_{gr} | Nₒₓ |
|---|---|---|---|---|---|---|---|
| Sample | I_{D}/I_{G} | %^{a)} | %^{a)} | %^{b)} | %^{b)} | %^{b)} | %^{b)} |
| NC—Mg | 1.29 | 5.8 | 0.13 | 27 | 14 | 47 | 12 |
| NC—Ca | 1.22 | 7.7 | 0.21 | 22 | 30 | 35 | 12 |
| NC—Sr | 1.13 | 5.6 | 0.09 | 27 | 19 | 36 | 18 |
| NC—Ba | 1.24 | 4.5 | 0.04 | 24 | 24 | 33 | 18 |

^{a)}Elemental analysis by ICP-MS, in duplicate.
^{b)}at %, by deconvolution of the N 1s XPS.

The distribution of binding states of surface nitrogen and carbon atoms was further analyzed by XPS in the N 1s and C 1s regions (FIG. 21). Several nitrogen types contribute to the N is spectrum, deconvoluted into pyridinic (Np), pyrrolic/pyrimidonic (Npy), graphitic (Ng), and oxidized (Nox) nitrogens. Their relative proportions vary between the four carbons, but the fraction of pyridinic nitrogen, an important contributor to ORR activity, is overall quite constant (1.1-1.7 wt %,) and sufficient for effective ORR electrocatalysis.

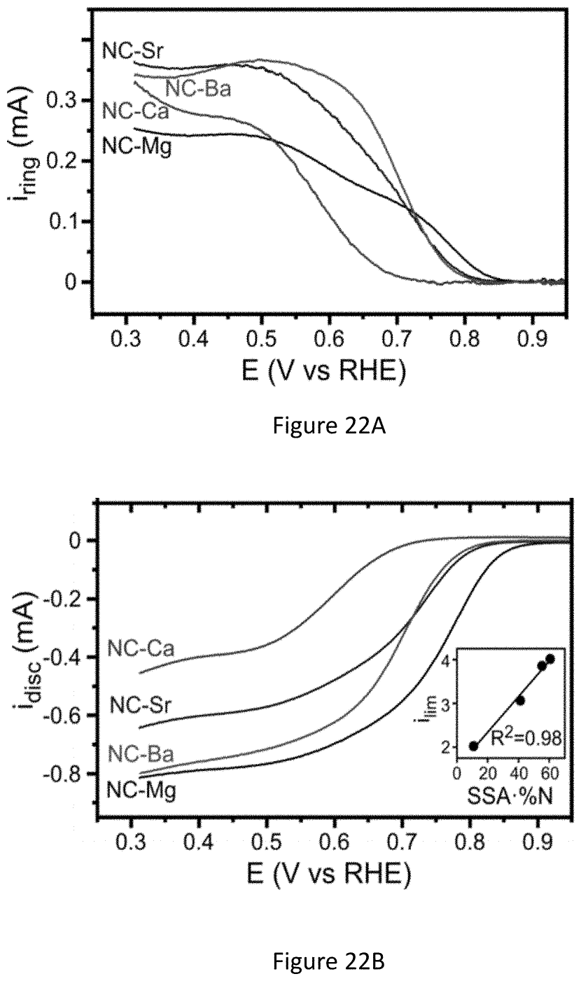

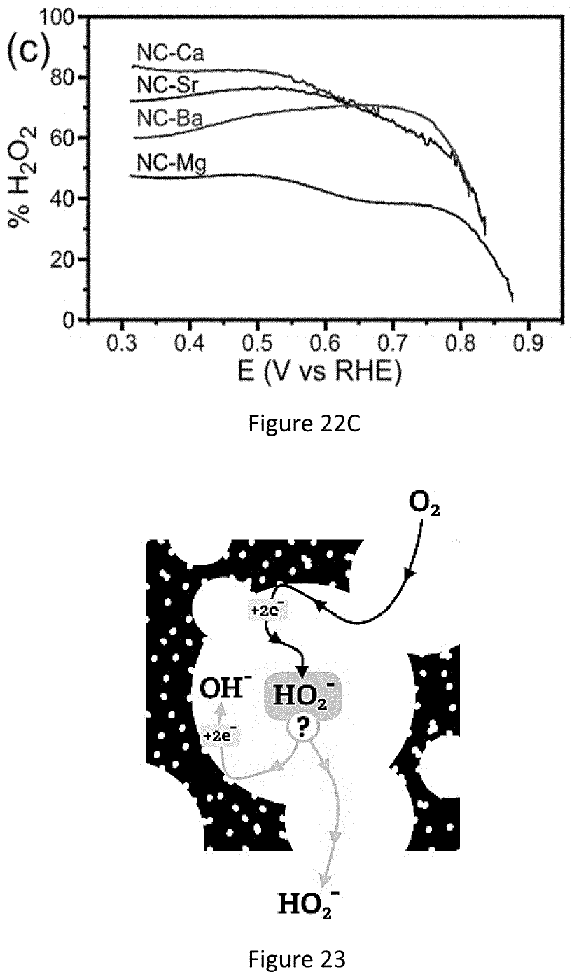

The similarities in carbon composition along the series, in contrast to the far-swinging differences in porosity, suggest that the ORR activity of these catalysts will depend chiefly on their microstructure. To investigate this dependence, the inventors studied the activity of NC-M carbons towards the ORR, using a rotating ring-disc electrode in an O₂(g)-saturated 0.1 M KOH electrolyte. All carbons demonstrated cathodic currents on the disc under mass-transport controlled conditions (1600 rpm, FIG. 22B), yet differed in their H₂O₂ yields (measured on the ring, Ering=1.3 V vs. RHE, FIG. 22A and FIG. 22C). The half-wave potentials and limiting current densities testify to good ORR performance, and are sufficient for studying how morphology affects ORR activity and selectivity. NC-Mg was the most active electrocatalyst of the four. It showed the earliest onset for ORR, 0.93 V vs. RHE (defined as 1% of the limiting current at 0.35 V, after correction for capacitive currents), the highest limiting current density (4.1 mA/cm² at 0.31 V), and the lowest rates of peroxide formation. NC-Ca performed worst, with the most negative onset (0.75 V), lowest limiting current density (2.3 mA/cm² at 0.31 V) and most peroxide formed. NC-Sr activity was intermediate between the two, and NC-Ba is almost as active as NC-Mg in limiting current at potential 0.4 V, but more negative onset potential (0.83 V) and higher rates of peroxide formation. Koutecky-Levich analysis of the four materials under mass-transfer-controlled conditions (E=0.7 V vs. RHE) shows that NC-Mg and NC-Ba have similar electron transfer numbers (3.85 and 4.15, both near 4 with some experimental errors). The values on NC-Sr and NC-Ca are lower (3.56 and 2.78), in line with their higher peroxide yields.

In N-doped carbons, the nitrogen dopants typically contribute most of the ORR activity, well ahead of the catalytic activity of carbon defect sites. Thus, the ORR current densities catalyzed by the carbons depend on the number of exposed nitrogens. To estimate this value, the inventors can multiply the surface N content by the BET SSA. The number of exposed N atoms, although a rough estimate, is in perfect linear correlation with the ORR activity, as measured by the limiting current density at E=−0.6 V vs. RHE and rotation rate 1600 rpm (FIGS. 22A-C, inset). This correlation is weaker when ORR activity is compared solely to SSA or to N content. This indicates that the N atoms are indeed responsible for ORR activity; that they are highly similar across the series; and that the chief parameter at play is the degree of N-site exposure. This further stresses the importance of the pore structure in determining activity. Even the different onset potentials for ORR (ranging in 150 mV between NC-Mg and NC-Ca), often signifying inherently different catalysis mechanisms, could be explained by flow-enhancing porosity.

Alkaline ORR on N-doped carbons begins with a 2e electro-reduction yielding a peroxide intermediate (Eq. 6). The peroxide can either (1) escape, (2) be reduced further by another 2e (Eq. 7), or (3) be disproportionated (Eq. 8). Interestingly, the carbons' microstructure has a striking effect on the ORR selectivity (2e⁻ vs. 4e⁻), as gauged by their different peroxide yields. On each of the NC-M carbons, the disc and ring reactions start at the same onset potential, suggesting they begin producing the HO₂ intermediate simultaneously with O₂ reduction (FIG. 22B). However, peroxide yields on NC-Mg are lower throughout the potential range, and especially at low current densities (potential range from −0.85 to −0.6 V vs. RHE, FIG. 22C). On the other carbons, the peroxide yields rise fast and reach higher plateaus.

O₂+2e⁻+H₂O [symbol] HO₂⁻+OH⁻ Eq. 6

HO₂⁻+2e⁻+H₂O [symbol] 3OH⁻ Eq. 7

HO₂⁻→½O₂+OH⁻ Eq. 8

The inventors propose that the differences in ORR selectivity stem from a competition between the kinetics and mass transfer of peroxide intermediates in the mesopores (as described schematically in FIG. 23). First, O₂ diffuses into the carbon, and is reduced to HO₂⁻ by a 2e⁻ process. The fate of the peroxide intermediate depends on its confinement: if it is in a large pore or near the particle surface, it will diffuse away, to be detected on the ring electrode. But if it is trapped within a smaller pore, it can be reduced by two more electrons (yielding an overall 4e⁻ reduction), and/or be disproportionated. If the 2e⁻ reduction (Eq. 6) and disproportionation (Eq. 8) occur repeatedly, the apparent number of electrons in the overall reduction will asymptotically approach 4e⁻. Similar confinement effects were invoked to explain why the apparent 4e⁻/2e⁻ selectivity in ORR rises with the thickness of the catalytic layer. Thicker layers may confine the peroxide intermediate in the inter-particle space, allowing it to complete its reactions.

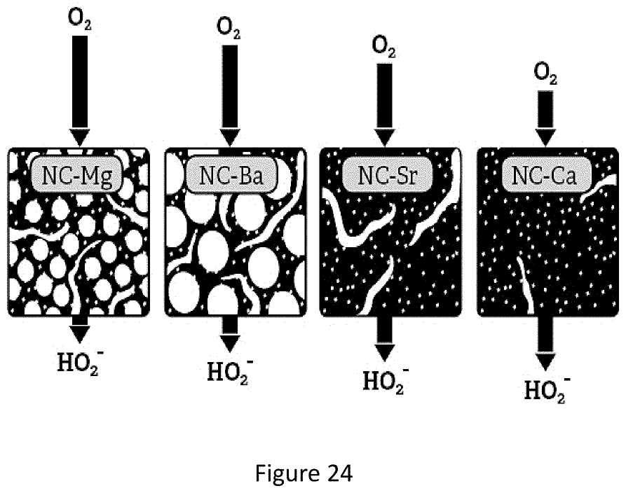

The pore-confinement mechanism can explain how morphology governs ORR activity across the series (FIG. 24). In strictly microporous NC-Ca, where bulk porosity is inaccessible, the ORR occurs on the outer surface of catalytic particles. This leads to low ORR currents on the disc, and to high yield of the peroxide ion on the ring—since the peroxide is not confined to internal pores and escapes after a mere 2e reduction. On NC-Sr, higher disc currents and an earlier onset correspond to the addition of macroporosity, which exposes many more micropores. However, there is still no confinement effect, and many peroxide intermediates can diffuse away. The highest ORR currents are observed on NC-Ba and NC-Mg, since their hierarchical macro-/meso-/microporosity allows the fastest mass transport of 02 into the pores even at high current densities. However, mesopore diameters in NC-Mg are smaller than in NC-Ba (˜20-40 nm vs. ˜80-150 nm, respectively). The smaller mesopores of NC-Mg confine the HO₂⁻ intermediates, leading to apparent 4e⁻ reduction, be it by the (2e⁻+2e⁻) or the (2e⁻+disproportionation) mechanism. In NC-Ba, in contrast, the mesopore diameters are 3-5 times larger than in NC-Mg, leading to easier escape of the peroxide intermediate. Diffusion of the final product, OH⁻(aq), is less dependent of pore structure, as it is highly abundant in the electrolyte. Overall, the rate of diffusion of O₂ into the pores, enabled by the hierarchical porosity, leads to high current densities on the disc. Simultaneously, the apparent 4e⁻/2e⁻ selectivity ratio depends on the pore confinement of peroxide intermediates (as described schematically in FIG. 23). Such confinement effects on ORR selectivity were previously considered to explain why a mesoporous g-C₃N₄/carbon composite is more selective towards 4e⁻ reduction than a macroporous one.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A composition comprising a porous carbon material comprising mesopores, micropores, macropores, or any combination thereof, wherein said composition is characterized by (i) a total pore volume between of 0.01 cm³ g⁻¹ and 4 cm³ g⁻¹ and (ii) a specific surface area (SSA) between 50 m² g⁻¹ and 2000 m² g⁻¹.

2. The composition of claim 1, wherein said micropores are characterized by a total volume between 0.01 and 0.6 cm³ g⁻¹.

3. The composition of claim 1, wherein said mesopores and said macropores are characterized by a total volume between 0.09 and 4 cm³ g⁻¹.

4. The composition of claim 1, wherein said carbon material is doped with 0.2 at. % to 5 at. % nitrogen.

5. The composition of claim 1, wherein said pores are void.

6. The composition of claim 1, wherein said pores comprise an alkaline earth metal compound comprising magnesium, calcium, strontium, barium, or any combination thereof.

7. The composition of claim 6, wherein said alkaline earth metal compound is in the form of nanoparticles.

8. The composition of claim 7, wherein said nanoparticles are characterized by a diameter in the range of 1 nm to 60 nm.

9. The composition of claim 6, wherein said alkaline earth metal compound is characterized by crystallite size in the range of 3 nm to 40 nm, as determined by the Scherrer method.

10. The composition of claim 1, wherein said carbon material comprises graphite, carbon black, graphene, reduced graphene oxide, graphene oxide, carbon microfibers, carbon nanofibers, carbon nanotubes, carbon nanowires, glassy carbon, amorphous carbon, or any combination thereof.

11. The composition of claim 1, for use in hydrazine oxidation reaction (HzOR), oxygen reduction reaction (ORR), or both.

12. An article comprising the composition of claim 1, wherein said composition is deposited on at least one surface of said article.

13. The article of claim 12, in the form of an anode.

14. The article of claim 12, wherein the loading of said composition is in the range of 0.01 mg cm⁻² to 0.3 mg cm⁻².

15. An electrochemical cell comprising the article of claim 13.

16. The electrochemical cell of claim 15, configured to oxidize hydrazine at onset potentials in the range of 0.2 V vs. reversible hydrogen electrode (RHE) to 0.8 V vs. RHE.

17. A process of oxidizing hydrazine, the process comprising: (i) contacting a hydrazine containing solution with the electrochemical cell of claim 15, and (ii) applying an anodic electric potential to said electrochemical cell, thereby oxidizing said hydrazine.

18. A method for preparing the composition of claim 1, comprising:
(i) providing one or more earth metal-coordination polymer precursor comprising magnesium, calcium, strontium, barium, or any combination thereof; and
(ii) pyrolysing said earth metal-coordination polymer precursor, thereby obtaining said porous carbon material.

19. The method of claim 18, further comprising step (iii) of washing said doped earth metal-carbon material, thereby obtaining said porous carbon material.

20. The method of claim 18, wherein said pyrolysing is at a temperature ranging from of 450° C. to 1000° C.
